(19) United States
(12) Patent Application Publication
(10) Pub. No.: US 2015/0209207 A1
(43) Pub. Date: Jul. 30, 2015

(54) SEATING FUNCTION MONITORING AND COACHING SYSTEM

(71) Applicants: University of Pittsburgh - Of the Commonwealth System of Higher Education, Pittsburgh, PA (US); The United States Government as represented by the Department of Veterans Affair, Washington, DC (US)

(72) Inventors: RORY ALAN COOPER, GIBSONIA, PA (US); YU-KUANG WU, PITTSBURGH, PA (US); BRANDON JOSEPH DAVELER, PITTSBURGH, PA (US); HSIN-YI LIU, PITTSBURGH, PA (US); HONGWU WANG, PITTSBURGH, PA (US); JONATHAN L. PEARLMAN, PITTSBURGH, PA (US); GARRETT G. GRINDLE, PITTSBURGH, PA (US)

(21) Appl. No.: 14/609,747

(22) Filed: Jan. 30, 2015

Related U.S. Application Data
(60) Provisional application No. 61/933,672, filed on Jan. 30, 2014.

(51) Int. Cl. A61G 5/10; A61G 5/04

(52) U.S. Cl. CPC A61G 5/1056; A61G 5/1067; A61G 5/1075; A61G 5/04; A61G 2203/30; A61G 2203/42; A61G 2005/127

(57) ABSTRACT

A wheelchair system includes a wheelchair including at least one adjustable seating function, a sensor system in operative connection with the wheelchair which includes at least one sensor to measure or sense a position of the at least one adjustable seating function, a processor system in operative connection with the sensor system, a memory system in operative connection with the processor system, and a communication system in operative connection with the processor system. The communication system is, for example, adapted to wirelessly communicate with one or more remote systems (that is, a system remote from the wheelchair; for example a remote system or server, which may include a database). The wheelchair system further includes a user interface system in operative connection with the processor system and at least one application stored on the memory system and executable by the processor system. The at least one application is executable to provide information via the user interface system to a user of the wheelchair related to data from the sensor system to assist the user to adjust the position of at least one adjustable seating in accordance with parameters stored in the memory system.

### CROSS-REFERENCE TO RELATED APPLICATIONS

This application claims benefit of U.S. Provisional Patent Application Ser. No. 61/933,672, filed Jan. 30, 2014, the disclosure of which is incorporated herein by reference.

### GOVERNMENTAL INTEREST

This invention was made with government support under grant no. EEC-0540865 awarded by the National Science Foundation and grant nos. B3142C and B6591R awarded by the Department of Veterans Affairs. The government has certain rights in this invention.

### BACKGROUND

The following information is provided to assist the reader in understanding technologies disclosed below and the environment in which such technologies may typically be used. The terms used herein are not intended to be limited to any particular narrow interpretation unless clearly stated otherwise in this document. References set forth herein may facilitate understanding of the technologies or the background thereof. The disclosure of all references cited herein are incorporated by reference.

Both powered and manual wheelchairs often include adjustable position or seating functions so that a wheelchair user may, for example, adjust one or more of an angle of seat tilt, an angle of backrest recline, a seat elevation, a leg rest elevation, or another component affecting the position or posture of the user (sometimes collectively referred to herein as “seating functions”). Individuals with, for example, both upper and lower extremity impairment are often provided electric powered wheelchairs with powered seating functions (PSF), especially if they cannot independently reposition various seating element profiles/positions including seat base, seat back, leg rest, etc. A PSF (for example, enabling control of elevation, tilt, recline) is used to increase independent function, to reduce risk of pressure ulcers, to manage pain, and to reduce swelling. Unfortunately, many individuals do not use adjustable seating functions properly. For example, they don't tilt far enough or long enough or they don't use the controls in the proper sequence. Moreover, various seating element profiles can also be dangerous under certain conditions. For example, a seat back that is tilted at too great an angle while a wheelchair is on an incline presents a tipping risk.

### SUMMARY

In one aspect, a wheelchair system includes a wheelchair including at least one adjustable seating function, a sensor system in operative connection with the wheelchair which includes at least one of sensor to measure or sense a position of the at least one adjustable seating function, a processor system in operative connection with the sensor system, a memory system in operative connection with the processor system, and a communication system in operative connection with the processor system. The communication system is, for example, adapted to wirelessly communicate with one or more remote systems (that is, a system remote from the wheelchair; for example a remote system or server, which may include a database). The wheelchair system further includes a user interface system in operative connection with the processor system and at least one application stored on the memory system and executable by the processor system. The at least one application is executable to provide information via the user interface system to a user of the wheelchair related to data from the sensor system to assist the user to adjust the position of at least one adjustable seating function in accordance with parameters stored in the memory system. Adjustment of the position of the at least one adjustable seating function may, for example, reduce the likelihood of adverse health conditions associated with an excessive period of time in a certain position and/or increase stability of the wheelchair. The functionality of the at least one application may, for example, be provide by two or more applications, apps or programs and the phrase “at least one application” includes embodiments in which two or more applications having distributed functionality are executed.

In a number of embodiments, the wheelchair system includes a plurality of adjustable seating functions, and the sensor system includes a plurality of sensors. Each of the plurality of sensors is operable to or adapted to measure or sense a position of at least one of the plurality of adjustable seating functions. The at least one application may, for example, be executable to provide information to the user of the wheelchair related to the data from the sensor system to assist the user to adjust position of any one of the plurality of adjustable seating functions in accordance with the parameters stored in the memory system.

In a number of embodiments, the at least one application is adapted to generate messages via the user interface system regarding the plurality of adjustable seating functions based at least in part upon the parameters stored in the memory. The messages may, for example, include at least one of (or both of) reminders to the user to adjust the position of each of the plurality of adjustable seating functions (to, for example, reduce the likelihood of adverse health conditions) and warnings to the user regarding the position of at least one of the plurality of adjustable seating functions. The warnings may, for example, be based (at least in part) upon one or more of the parameters stored in memory and relating to the position of one of the plurality of adjustable seating functions relative to the position of another one of the plurality of adjustable seating functions, relating to the position of one of the plurality of seating functions relative to a measured orientation of the wheelchair, or relating to the position of one of the plurality of seating functions relative to a measured speed or acceleration of the wheelchair. The sensor system may, for example, further include at least one of a sensor to measure an orientation of the wheelchair (for example, longitudinal inclination, lateral inclination, etc.), a sensor to measure speed of the wheelchair or a sensor to measure acceleration of the wheelchair.

The at least one application may, for example, be adapted to store data regarding the reminders, user action on the reminders, the warnings, and/or user action on the warnings in the memory system. In a number of embodiments, the at least one application is adapted to transmit data regarding the reminders, user action on the reminders, the warnings, and/or user action on the warnings to at least one of the one or more remote systems via the communication system. The at least one application may also or alternatively be adapted to receive data from at least one of the one or more remote system to alter the parameters stored in the memory system.

In a number of embodiments, one or more of the generated messages (for example, reminders and/or warnings) are dependent upon at least one of a location of the wheelchair, a condition of the environment of the wheelchair, or an activity in which the user is involved. The sensor system may further include at least one of a sensor to determine the location of the wheelchair, at least one sensor to determine the condition of the environment of the wheelchair, or at least one sensor to determine the activity in which the user is involved. For example, parameters for generating reminders and/or warning may be varied depending upon, for example, whether a user is estimated to be or determined to be in an office, in a car, in a movie theater, etc.

In a number of embodiments, one or more of the plurality of adjustable seating functions include at least one powered seating functions. The plurality of adjustable seating function may also be manually adjustable. The plurality of adjustable seating functions may, for example, include angle of seat tilt, angle of backrest recline, leg rest elevation. The plurality of adjustable seating function may also include seat elevation.

The user interface system may, for example, include a display. Other user interface components or elements as known in the computer arts may also or alternatively be provided in the user interface system (including, for example, audible user interfaces, visual user interfaces and/or tactile user interfaces). The user interface system may include an input system to provide for input by the user. The display may, for example, be a touchscreen display. A keyboard, mouse and/or touchpad may also or alternatively be provided.

In a number of embodiments, the at least one application is further adapted to administer at least one questionnaire to a user. Data from the at least one questionnaire may, for example, be transmitted to the one or more remote systems via the communication system.

In a number of embodiments, the wheelchair is a powered wheelchair including a control system which includes a processor. The processor may, for example, be a component or element of the processor system. The sensor system, the communication system, and/or the user interface system may be a component of the control system or other system operatively connected to or integrated with the wheelchair.

In a number of embodiments, the at least one adjustable seating function includes a power seating function in operative connection with the control system of a powered wheelchair. The at least one application may, for example, be adapted to adjust the at least one adjustable seating function via the controller system (with or without user intervention).

In a number of embodiments, at least one processor of the processor system, at least on memory component of the memory system, at least one communication component of the communication system and at least one interface component of the interface system are provided by or are a component of a personal communication device. In a number of embodiments, the processor system, the memory system, the communication system and the interface system are embodied or integrated within the personal communication device. The personal communication device may, for example, be a smartphone or a tablet computer. In a number of embodiments, the personal communication device is a smartphone. One or more sensors of the sensor system may also be embodied within or integrated with the personal communication device.

The wheelchair system may, for example, further include personal communication system interface operatively connected to the wheelchair. The personal communication system interface may, for example, include a connector adapted to be placed in communicative connection with a cooperating connector of the personal communication device. The connector provides operative connection between the sensor system and the personal communication device. In a number of embodiments, the wheelchair is a powered wheelchair including a control system in operative connection with one or more of the plurality of sensors of the sensor system and the connector is in operative connection with the control system.

The at least one application may, for example, be stored on the at least one memory component of the personal communication device and may be executed by the at least one processor of the personal communication device. In a number of embodiments, the at least one application may, for example, be adapted to request data from the sensor system. The at least one application may, for example, run as a background service on the personal communication device. In a number of embodiments, the at least one application is adapted to sense when the personal communication system is in communication with sensor system and to automatically request data from the sensor system when the personal communication system is in communication with the sensor system. The at least one application may, for example, request data periodically from the sensor interface system as long as the sensor interface system is in communication with the personal communication device. In a number of embodiments, the at least one application stores data received from the sensor system on a memory card installed on the personal communication system or another memory component or memory module of the personal communication system.

The personal communication system interface may, for example, include a support or cradle including a seating for the personal communication device. The cradle may, for example, include a seating into which the personal communication device may be slid and a latching mechanism to secure the phone in the seating. The latching mechanism may, for example, be a hinged latch that is retained in a locked position via, for example, magnetism. In a number of embodiments, the support or cradle further includes the connector as described above. The connector may, for example, be positioned to connect with the cooperating connector of the personal communication device upon sliding the personal communication device into the seating of the support or cradle or otherwise placing the personal communication system in operative connection with the support or cradle. The connector may, for example, include a micro USB connector.

The connector may, for example, be adapted to be placed in operative connection with a battery system of the wheelchair (in the case of, for example, a powered wheelchair) and may provide power to the personal communication system/smartphone via, for example, the connector. The connector may, for example, be in operative connection with a DC/DC converter to covert power from the battery system to a voltage suitable for use by the personal communication system or to charge the personal communication system/smartphone. The connector system may, for example, be in operative connection with a sensor interface including a processor system. The sensor interface system may, for example, include at least one analog-to-digital converter in operative connection with the processor system of the sensor interface system. The sensor interface system may, for example, be adapted to provide digital data to the personal communication device. In a number of embodiments, the personal communication system may, for example, communicate with the sensor system wirelessly.

In a number of embodiments, the sensor system includes a sensor to sense the angle of seat tilt, a sensor to sense the angle of backrest recline, and a sensor to sense the leg rest elevation. The sensor to sense the angle of seat tilt may, for example, include a first accelerometer attachable to a seat of the wheelchair. The sensor to sense the angle of backrest recline may, for example, include a second accelerometer attachable to a backrest of the wheelchair. The sensor to sense leg rest elevation may, for example, include a third accelerometer attachable to a leg rest of the wheelchair. The system may also, for example, include a sensor to sense seat elevation.

A sensor to sense an angle of inclination of the wheelchair may, for example, include an accelerometer in operative connection with the wheelchair. The sensor to sense the angle of inclination of the wheelchair may, for example, be a sensor of the personal communication device/smartphone. The sensor of the personal communication system/smartphone may, for example, include an accelerometer, a gyrometer or an inclinometer.

In another aspect, a wheelchair system includes a wheelchair includes at least one adjustable seating function, a sensor system in operative connection with the wheelchair including at least one of sensor to sense a position of the at least one adjustable seating function, a processor system in operative connection with the sensor system, a memory system in operative connection with the processor system, and a user interface system in operative connection with the processor system. The wheelchair system further includes at least one application stored on the memory system and executable by the processor system to provide information via the user interface system to a user of the wheelchair related to data from the sensor system to assist the user to adjust the position of at least one adjustable seating function in accordance with parameters stored in the memory system and to provide messages comprising at least one of reminders to the user via the user interface system to adjust the position of the at least one adjustable seating function and warnings to the user via the user interface system regarding the position of at least one adjustable seating functions.

In a number of embodiments, the one or more of the generated messages are dependent upon at least one of a location of wheelchair, a condition of the environment of the wheelchair, or an activity in which the user is involved. The sensor system may, for example, further include at least one of a sensor to determine the location of the wheelchair, a sensor to determine the condition of the environment of the wheelchair, or a sensor to determine a variable related to the activity in which the user is involved.

In another aspect, a method of providing information to a user of a wheelchair to assist the user to adjust a position of at least one adjustable seating function of the wheelchair includes providing a sensor system in operative connection with the wheelchair and including at least one of sensor to sense a position of the at least one adjustable seating function, providing a processor system in operative connection with the sensor system, providing a memory system in operative connection with the processor system, providing a communication system in operative connection with the processor system, the communication system being adapted to wirelessly communicate with one or more remote systems, providing a user interface system in operative connection with the processor system, and executing at least one application stored on the memory system via the processor system to provide information via the user interface system to a user of the wheelchair related to the data from the sensor system to assist the user to adjust the position of at least one adjustable seating function in accordance with parameters stored in the memory system.

In another aspect, a method of providing information to a user of a wheelchair which includes at least one adjustable seating function. The method includes measuring a position of the at least one adjustable seating function using a sensor of the sensor system, and communicating data from the sensor system to a personal communication device. The personal communication device includes a communication system, a processor system, a memory system in operative connection with the processor, an operating system stored in the memory system and executable by the processor system, a user interface system in operative connection with the processor to provide information to the user, and at least one application stored thereon and executable by a processor system of the personal communication device. The method further includes executing the at least one application to provide information via the user interface system to a user of the wheelchair related to the data from the sensor system to assist the user to adjust the position of at least one adjustable seating function in accordance with parameters stored in the memory system. The personal communication device may, for example, be a smartphone or a tablet computer. In a number of embodiments, the personal communication device is a smartphone.

In another aspect, a system is adapted to be placed in operative connection with a wheelchair. The wheelchair includes at least one adjustable seating function and a sensor system including at least one a sensor to sense a position of the at least one adjustable seating function. The system includes a personal communication device which includes a communication system, a processor system, a memory system in operative connection with the processor, an operating system stored in the memory system and executable by the processor system, a user interface system in operative connection with the processor, and at least one application stored thereon and executable by the processor system to provide information via the user interface system to a user of the wheelchair related to data from the sensor system to assist the user to adjust the position of at least one adjustable seating function in accordance with parameters stored in the memory system. The system may, for example, further include a sensor interface system which is operable to communicate data from the sensor system to the personal communications device. In a number of embodiments, the communication system is adapted to wirelessly communicate with one or more remote systems.

In a further aspect, a system adapted to be placed in operative connection with a wheelchair including seating functions includes at least one sensor for sensing a position of at least one of the seating function (for example, at least one of an angle of seat tilt, an angle of backrest recline, a seat elevation, or a leg rest elevation), a personal communication device including a communication system, a processor system, a memory system in operative connection with the processor, an operating system stored in the memory system and executable by the processor system and a user interface system in operative connection with the processor to provide information to the user, and a sensor interface system. The sensor interface system is operable to communicate data from the at least one sensor to the personal communications device. The personal communication device further includes at least one application stored thereon and executable by the processor system to provide information to a user of the wheelchair related to the data from the at least one sensor.

In still a further aspect, a method of providing information to a user of a wheelchair including seating functions includes collecting data of at least one sensor for sensing a position of at least one of the seating functions (for example, at least one of an angle of seat tilt, an angle of backrest recline, a seat elevation, or a leg rest elevation) via a sensor interface system, and communicating data from the sensor interface system related to data collected from the at least one sensor to a personal communication device. The personal communication device includes at least one application stored thereon and executable by the processor system to provide information to a user of the wheelchair regarding the seating functions and related to the data communicated from the sensor interface system.

The present devices, systems, and methods, along with the attributes and attendant advantages thereof, will best be appreciated and understood in view of the following detailed description taken in conjunction with the accompanying drawings.

### BRIEF DESCRIPTION OF THE DRAWINGS

FIG. 1 illustrates a side view of an embodiment of a system hereof including a smartphone interface.

FIG. 2 illustrates an embodiment of a smartphone interface for interactive connection with a smartphone, wherein the smartphone is aligned for docking therein.

FIG. 3 illustrates the smartphone interface of FIG. 2A with the smartphone in operative connection therewith.

FIG. 4 illustrates schematically the system of FIG. 1.

FIG. 5 illustrates a comparison of seat angle as determined with an accelerometer and with an inclinometer.

FIG. 6A illustrates an embodiment of a method for storing data locally on a smartphone and transmitting data files to a remote server.

FIG. 6B illustrates an embodiment of folder and files saved locally on an SD card of a smartphone, which may be uploaded to a server.

FIG. 6C illustrates an embodiment of a flow chart for a program for sending data to a server.

FIG. 6D illustrates an embodiment of a database for storage of data on reminders and/or warning.

FIG. 6E illustrates an embodiment of a database for storage of data on personal seating functions.

FIG. 7 illustrates an embodiment of a flowchart for input of clinician-determined settings or parameters into the system.

FIG. 8 illustrates an embodiment of a flowchart for a background service program hereof.

FIG. 9 illustrates an embodiment of a flowchart for detecting the need for, setting forth and logging repositioning reminders.

FIG. 10A illustrates an embodiment of a flow chart for detecting the need for and setting forth safety warnings related to instability caused by leg rest elevation angle settings without correspondingly sufficient backrest recline angle.

FIG. 10B illustrates an embodiment of a flow chart for detecting the need for and setting forth safety warnings related to instability caused by certain backrest recline angle settings without sufficient tilt angle.

FIG. 10C illustrates an embodiment of a flow chart for detecting the need for and setting forth safety warnings related to instability caused by excessive backrest recline angle and tilt angle.

FIG. 11A illustrates an embodiment of a screenshot for a display of the smartphone providing a reminder of seating function usage to address excessive leg rest.

FIG. 11B illustrates an embodiment of a screenshot for a display of the smartphone providing a reminder of seating function usage to address pressure relief.

FIG. 11C illustrates an embodiment of a screenshot for a display of the smartphone providing a reminders of seating function usage to address pressure relief as well as instructions indicating how the users should adjust the user's powered wheelchair.

FIG. 12A illustrates an embodiment of a screenshot for a display of the smartphone providing information regarding current states of a wheelchair setup.

FIG. 12B illustrates an embodiment of a screenshot for a display of the smartphone providing data regarding pressure relief actions and warnings/reminders over a period of time.

FIG. 12C illustrates an embodiment of a screenshot for a display of the smartphone providing a menu for accessing various information and/or functions.

FIG. 12D illustrates an embodiment of a screenshot for a display of the smartphone providing information regarding use of the system, including the smartphone interface of FIG. 2A.

FIG. 12E illustrates an embodiment of a screenshot for a display of the smartphone providing information regarding settings for the system hereof.

FIG. 13 illustrates another embodiment of a screenshot for a display of the smartphone providing information regarding current states of a wheelchair setup.

FIG. 14A illustrates an embodiment of a display of a summary of seating function compliance, safety warning etc. for a particular user.

FIG. 14B illustrates an embodiments of a graphical display of repositioning compliance and safety warnings.

FIG. 15 illustrates an embodiment of a flowchart for a questionnaire app

FIG. 16A illustrates an embodiment of a display via which a user can select to answer a questionnaire.

FIG. 16B illustrates an embodiment of a display of instructions for answering a questionnaire.

FIG. 16C illustrates an embodiment of a display providing an example of a question posed in a questionnaire and choices for answers.

FIG. 16D illustrates an embodiment of a display providing an example of a question posed in a multidimensional health locus of control questionnaire and choices for answers.

FIG. 17 illustrates and embodiment of flowchart for using the systems and methods hereof to modify system settings, wheelchair settings, and/or healthcare actions.

FIG. 18 illustrates an embodiment of a flow chart for inputting or changes user-defined settings.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As used herein and in the appended claims, the singular forms “a,” “an”, and “the” include plural references unless the context clearly dictates otherwise. Thus, for example, reference to “a sensor” includes a plurality of such sensors and equivalents thereof known to those skilled in the art, and so forth, and reference to “the sensor” is a reference to one or more such sensors and equivalents thereof known to those skilled in the art, and so forth. Recitation of ranges of values herein are merely intended to serve as a shorthand method of referring individually to each separate value falling within the range. Unless otherwise indicated herein, and each separate value as well as intermediate ranges are incorporated into the specification as if it were individually recited herein. All methods described herein can be performed in any suitable order unless otherwise indicated herein or otherwise clearly contraindicated by the text.

In a number of representative examples, devices, systems and methods hereof are discussed in connection with power seating functions or PSF of powered wheelchairs. However, the devices, systems and methods hereof can be used in connection with any wheelchair including adjustable positions or seating functions which allow users to adjust their position or posture, including manual wheelchairs or powered wheelchairs which include manually adjustable seating functions. Powered wheelchairs equipped with powered seating functions or PSF, including, for example, seat tilt, backrest recline, leg rest elevation, and seat elevation functions, allow users to adjust their posture independently to assist with daily tasks and preventing secondary complications. Appropriate use of PSFs can enhance sitting stability and postural control, decrease the risk of developing pressure sores through performing pressure relief, and manage other systematic issues such as limb contractures, muscle tightness, orthostatic hypotension, autonomic dysreflexia, limb edema and so on. In general, clinicians may provide recommendations or guidance with respect to PSF usage to prevent or limit secondary complications. However, compliance with clinical guidance on PSF usage is very low among, for example, powered wheelchair users, leading to a high risk for secondary complications such as pressure sores, chronic pain, fatigue, edema, limitations to activities of daily living, and other conditions.

In a number of representative embodiments, the systems and methods hereof monitor seating function (SF) usage such as powered seating function (PSF) usage and provide real time and tailored feedback, including, for example, reminders and instructions, to facilitate compliance with preset parameters or rules (for example, developed on the basis of clinical recommendations) about using SFs for health management and driving safety. The monitoring of seating functions and other data/wheelchair usage by the systems hereof can also, for example, be used/analyzed to improve wheelchair design.

In a number of representative embodiments, data is processed and information is provided to the wheelchair user (and communicated to one or more remote systems), at least in part, via a personal communication device. However such functions may be carried out (in whole or in part) via systems in operative connection with, embedded within, or integrated with a wheelchair. For example, the control system and onboard sensors of a powered wheelchair may be altered to provide functionality as described herein, and a communication system may be integrated or operatively connected with the control system. Likewise, such functionality may be distributed between systems integrated with wheelchair and, for example, another system such as a personal communications device which may be place in operative connection with the wheelchair. The use of personal communication devices may, for example, provide one manner of retrofitting existing wheelchairs to provide devices, systems and methods hereof.

As used herein, the term “personal communications device” refers to a portable or mobile device which includes a communication system, a processor system, a user interface system (for example, a visual feedback system including a touchscreen or other display, an auditory feedback system, and a tactile feedback system, an user input system etc.) and an operating system capable of running general-purpose applications. Examples of personal communications devices include, but are not limited to, smartphones, tablet computer and custom devices. As used herein, the term “tablet computer” or tablet, refers to a mobile computer with a communication system, a processor system, at least one user interface as described above (typically including a touchscreen display), and an operating system capable of running general-purpose applications in a single unit. As used herein, the term “smartphone” refers to a cellular telephone including a processor system, at least one user interface as described above (typically including a touchscreen display), and an operating system capable of running general-purpose applications. Such personal communication devices are typically powered by rechargeable batteries and are housed as a single, mobile unit. Moreover, in a number of embodiments personal communications devices are able accept input directly into a touchscreen (as opposed to requiring a keyboard and/or a mouse). Personal communications devices as typically provide for internet access through cellular networks and/or wireless internet access points connected to routers. A number of representative embodiments of systems and/or methods hereof are discussed in connection with the user of a smartphone as the personal communication device.

Parameters for determining reminders and instructions may, for example, be personalized according to individual needs. Moreover, data from usage of the systems hereof (for a single user and/or over multiple users) may be used to personalize parameters or settings for a particular user. In a number of embodiments, the systems are attachable to wheelchairs and are quite simple to install (for example, requiring only simple hand tools for installation). The systems hereof can readily be installed on virtually any wheelchairs. Moreover, the user interface is user-friendly and may be incorporated into, for example, regular smartphone usage. In addition to reminding wheelchair users to perform appropriate repositioning using seating functions for health management, the systems hereof may also monitor seating functions to ensure appropriate seating angles and/or other seat setting for safety. In a number of embodiments, the systems hereof may monitor seating function settings, and also communicate with a controller of the wheelchair to effect changes in such settings. A setting may be changed automatically without manual intervention in some cases. Also, a user may, for example, receive a message/request from the system to change a setting and have the choice to accept the request. Upon acceptance of the request, the system can initiate the setting change.

The real time SF usage reminders from the system may, for example, instruct users to adjust their powered wheelchair for various purposes based on clinical recommendations and environmental settings/conditions, which may, for example, extend training beyond the clinical setting. In addition, with periodic repositioning reminder, users may follow the instruction to perform an effective positioning to reduce the risk of, for example, developing pressure sores, minimize fatigue and/or pain, and decrease edema in lower limbs. Moreover, clinicians are be able to provide personalized health education and coaching by customizing the feedback of the systems hereof for each powered wheelchair user. A clinician or other authorized person can, for example, access systems hereof remotely (if allowed/enabled by a user) via the communication system (for example, of a personal communication device) to, for example, modify one or more parameters or settings. For example, the frequency of reminders for position adjustment of seating function may be adjusted for a particular user. Moreover, a technician may be able to review data remotely to schedule maintenance.

In a number of embodiments, the systems hereof 1) determine the need for a reminder and/or warning and the timing thereof, 2) remind/warn a user about the time to perform repositioning; 3) provide real time audio, visual, audio-visual/video and/or tactile feedback about the seating angles to guide the users to adjust to the desired position; and 4) provide real time audio, visual, audio-visual and/or tactile feedback to guide the users to stay in the position for the desired duration, and 5) confirm the completion of the repositioning. Appropriate repositioning may, for example, include repositioning seating angles (for example, tilt the seat 30° plus recline the backrest 20°), frequency (for example, once every hour), and positioning duration (for example, stay in the designated position for 2 minutes). Clinicians may recommend repositioning regimes based on individual needs and preference. The user may also set or adjust parameters/settings. The parameters/settings of the devices, systems and methods hereof may thus be partially or completely customizable for each user. In a number of embodiments, the user need not press any button to reset or start the timer.

The system may also detect inappropriate combinations of the seating angles/setting and inclining angles of the wheelchair/driving surface, display or otherwise provide a warning about the detected safety issue, and display visual/auditory/tactile feedback to adjust the seating angles according to the condition for increasing stability or decreasing stress on the user. For example, some combination of the seating angles may, over-stretch the user's legs or decrease stability of the wheelchair. When driving uphill, for example, the chair may be at risk of tipping backward if the seat is tilted backward too far. Although seating functions can be used to assist with many daily activities and health management, the user may also be made aware of some safety issues induced by some combinations of seating angles.

A location sensor or system (for example, using a global position system or GPS) of smartphone 100 may, for example, enable communication/interaction with one or more information databases (for example, a web-based information database) so that information related to position/location (such as information regarding a path that the wheelchair is travelling) can be incorporated into determining safe ranges of setting. A pathway measurement/characterization tool and database for defining pathway condition/roughness is, for example, disclosed in U.S. patent application Ser. No. 14/597,721, filed Jan. 15, 2015, the disclosure of which is incorporated herein by reference. Moreover, various sensor such as GPS, differential GPS. microphones, light sensors, and internal measurement unit (IMU) sensor, location sensors, sound level sensors, setting sensors and situation sensors may be included in systems hereof. Using predetermined rules and, in some embodiments, machine learning algorithms, data from such sensors may, for example, assist in estimating or determining the location of a wheelchair user as well as the nature of an activity in which the user is partaking (for example, if the user is in a crowded room, outdoors, in a meeting). Settings and parameters of the systems hereof may, for example, be dependent upon the circumstances or context of the user's surroundings. In that regard, data from such sensor may be used to tailor how the systems hereof communicates with the user. For example, if it is determined from, for example, location, sound levels, lighting (indoor lights have a predictable signal) etc., that the user is in an indoor meeting, feedback to the user may be tailored to the determined “context”. The user may, for example, be prompted to confirm a determination of location/activity.

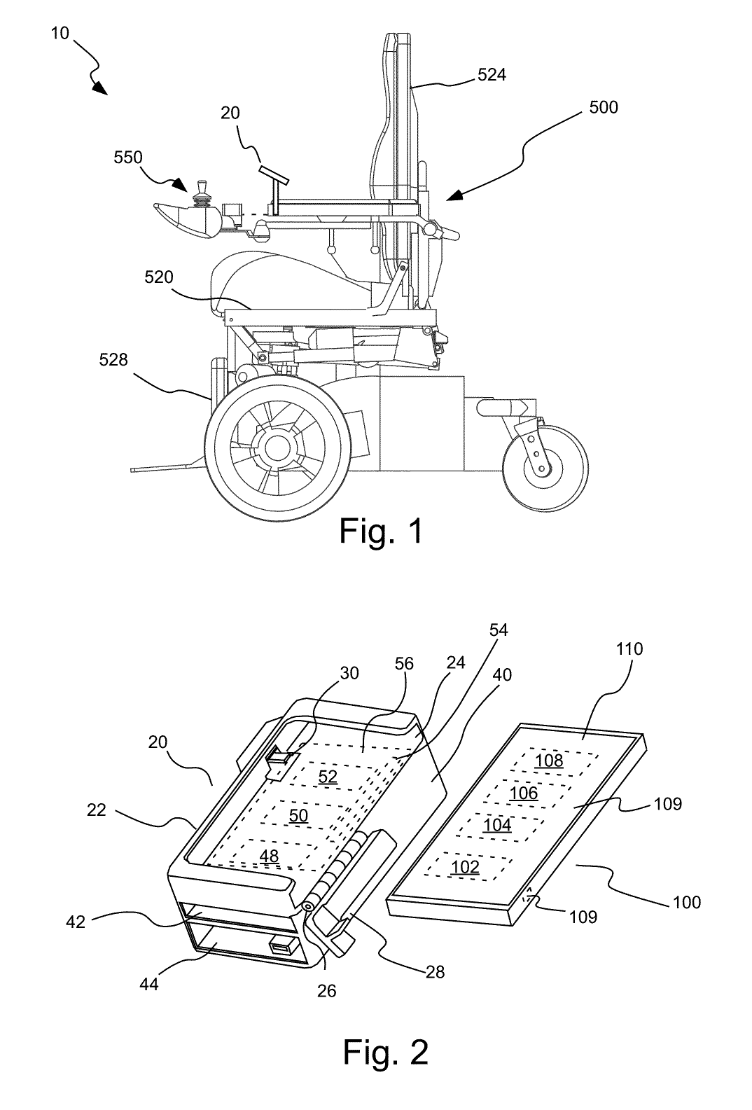

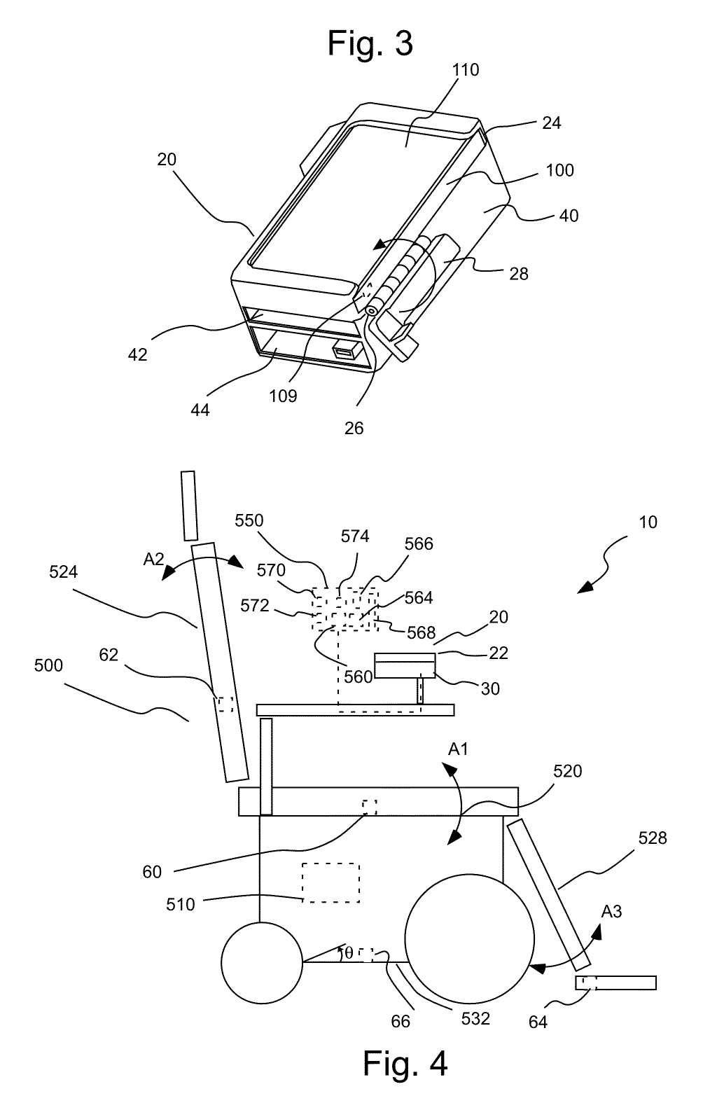

FIGS. 1 through 4 illustrate a representative embodiment of a system 10 hereof (sometimes referred to as a virtual seating coach of VSC system or application) for use in connection with a powered wheelchair 500 including powered seating functions as described above. Referring, for example, to FIGS. 2 and 3, system 10 includes a smartphone interface system 20 which includes a smartphone support or cradle 22 including a seating for a smartphone 100. A power/communication interface or connector 30 is provide to connect with a cooperating power/communication interface or connector (not shown) on smartphone 100. In a number of embodiments, connector 30 includes a micro USB connector which is positioned so that a user need only slide smartphone 100 into phone seating 24 of cradle 22 to make the connection of smartphone 100 to micro USB connector 30. As known in the art and as illustrates schematically in FIG. 2, smartphone 100, includes a processor system 102, a memory system 104, a communication system 106 (which may, for example, include wireless cellular telephone connectivity (providing telephone and internet connectivity), radio-band or WiFi internet connectivity, BLUETOOTH wireless connectivity, infrared wireless connectivity, etc.) and an interface system 108 (including, for example, a touchscreen display 110). Smartphone 100 may also include a sensor system 109 including, for example, GPS, one or more accelerometers etc.

Smartphone cradle 22 is attached to wheelchair 500 as, for example, illustrated in FIGS. 1 and 4 and holds a user's personal smartphone 100 on powered wheelchair 500 in a manner to allow the user to see displayed messages and feedback provided on display 110 of smartphone 100. Cradle 22 further provides a stable and secure connection for smartphone 100 to, for example, receive power from batteries 510 of powered wheelchair 500 and to receive transferred data from one or more sensors of a sensor system as further described below. Cradle 22 holds smartphone 100 securely and makes, for example, USB connection possible and relatively easy for people with impaired hand function. In a number of embodiments, cradle 22 holds smartphone securely via cooperation of a hinge joint 26 to open or close a latch mechanism 28, which may, for example, cooperate with a magnetic locking mechanism (not shown).

In the illustrated embodiment, smartphone interface system 20 further includes an electronic case or enclosure 40 including, for example, ports 42 and 44 via which power, electronics and/or communications connections can be made with electronic components within electronics case 40. Electronic case 40 may, for example, house a sensor interface system including, for example, connectors 48 (for example, one or more analog input ports) for connection to system sensors, a processor system including one or more microcontrollers 50 for data processing, and a DC-DC converter 52 to convert electric power from powered wheelchair batteries 510 in a manner appropriate for charging smartphone 100 and a memory system 54. Connector(s) 48, microcontroller(s) 50, DC-DC converter(s) 52 and memory system (s) 54 are illustrated schematically in FIG. 2. DC-DC converter 52 may, for example, convert 24 volts (battery output voltage for batteries 510) to 12 volts for use by the charging system of smartphone 100. System 10 may, for example, obtain power directly from the powered wheelchair battery or batteries 510 through the wheelchair's charging plug (not shown).

In a number of embodiments, a number of sensors are attached or placed in operative connection with various elements or components of wheelchair 500 to sense, for example, seating states/positions (whether powered or manual) as well as wheelchair inclination. In the embodiment illustrated in, for example, FIG. 3, a sensor system including such sensors may, for example, include four accelerometers 60, 62, 64 and 66. Accelerometer 60 is placed in operative connection with seat pan 520; accelerometer 62 is placed in operative connection with backrest 524, accelerometer 64 is placed in operative connection with leg rest 528; and accelerometer 66 is placed in operative connection with wheelchair base 532, to detect the tilt angle (A1), recline angle (A2), leg rest angle/elevation (A3), and wheelchair base angle/inclination (θ), respectively (see FIG. 3). Two vectors may, for example, be used to determine the tilt angle via accelerometers 60, 62, 64 and 66. In a number of embodiments, each of accelerometers 60, 62, 64 and 66 was connected to wheelchair 500 using a hook-and-loop type fastener. Other simple fasteners such as tie-wraps or double-stick foam may be used. A supply of 3.3 volts may, for example, be provided to the accelerometers via a microcontroller board 56 of sensor interface system 54 (within electronics case 40). In a number of embodiments, the accelerometers' signal output was connected to single analog input port 48 in operative connection with microcontroller board 56 for analog-to-digital conversion. Digital data was sent to smartphone 100 (for example, a smartphone using the ANDROID® operating system of Google, Inc. of Mountain View, Calif., which is available from virtually any wireless telephone provider) via a USB cable (not shown). Alternatively, the BLUETOOTH wireless communications protocol (managed by the Bluetooth Special Interest Group, headquartered in Kirkland, Wash.) or another wireless communications protocol can be used to provide communication between the sensor interface system and smartphone 100 as well as between system sensors and the sensor interface system.

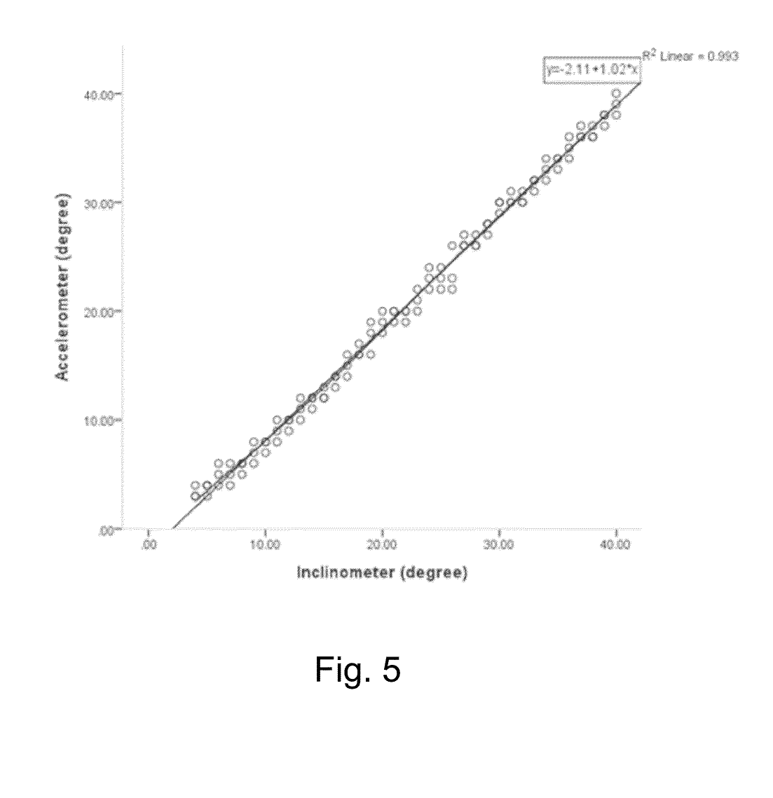

In a number of embodiments, smartphone 100 was mounted on an armrest of powered wheelchair 500 via smartphone interface 20. In a representative study, a standard inclinometer was place on seat pan 520 as a “gold standard” next to accelerometer 60 to measure the seat tilt angle of powered wheelchair 500. To enable a stable angle measurement output from accelerometer 60, a Kalman filter (initial state covariance (P)=1, state noise covariance (Q)=0.0001, measurement noise covariance (R)=0.15) with moving average (window size=3 data points) was applied. The sampling rate was set as 5 data points/second. To avoid angle variation caused by the voltage fluctuation, the angle calculated by accelerometer 60 was rounded off to the nearest integer. As can be seen from the data of FIG. 5, the angles from the inclinometer and accelerometer 60 have a very high correlated relationship (R²=0.993). The linear regression formulation is shown as follows:

Accelerometer=1.0245*Inclinometer+Normal(−2.10653,0.892641)

In the above equation, the Normal (−2.10653, 0.892641) shows the 95% confident interval of the interception of this linear regression. As a result, the variation of angle error between accelerometer 60 with inclinometer is −1.57±1.86 degree with the Kalman filter and moving average setting. As known in the art, a Kalman filter uses the dynamics model of a system (e.g., physical laws of motion), known control inputs to that system, and multiple sequential measurements from sensors to form an estimate of the system's varying quantities that is more accurate than an estimate obtained using any one sensor/measurement. For the studies of FIG. 5, we moved the tilt angle from 4 degree (minimal tilt position related to ground) to 40 degree with 1 degree interval. We recorded both angle from the inclinometer and accelerometer respectively, and performed linear regression.

In the embodiment described above, system 10 monitors powered seating function usage through accelerometers 60, 62, 64 and 66. In a number of embodiments, a first software program in the form of a first app or application installed on smartphone 100 (or other personal communication system) processes the sensor data (for example, collected by accelerometers 60, 62, 64 and 66). A second software program in the form of a second app (sometimes referred to herein as a coaching app) installed on smartphone 100 executes a coaching algorithm, which, for example, determine a message and then displays the coaching message on smartphone display 110 to guide the user to perform repositioning. The first app and the second app may be downloadable to the mobile personal communication device in a manner known in the personal communication device arts. The second app may also do one or more of the following: display real time visual and/or audio feedback to the user, store the seating function usage data, generate seating function usage profile/reports (for example, with charts and stats summary for future review), and send data and/or reports to, for example, a clinician under the user's permission. The functions of the first app and second app as described above may, for example, be integrated into a single application or distributed over any number of applications.

A number of representative variables/measurements for tracking and/or inclusion in reports include time, tilt angle, recline angle, leg rest angle, inclinometer angle, left wheel encoder tick, right wheel encoder tick, seat elevation and seat switch (on/off). For example, such variable may be set forth in columns with each row corresponding to a time point. Compliance with repositioning reminder may be tracked with categories of response such as reminder ignored, reminder dismissed, and repositioning completed. Similarly compliance with safety warnings may be tracked. Categories of response to be tracked may, for example, include warning ignored, warning dismissed and positioning for safety was followed and completed. The number of times such actions are taken over a period of time (for example, one day or 24 hours) may be tracked.

A number of variables may be reported for clinical interpretation. Such variables may, for example, include wheelchair occupancy time (for example, as determined using a seat switch) and driving distance (for example, as determined via one or more wheel encoders). Further, power seating function usage may be tracked by, for example, establishing various ranges of seat position and leg rest position as set forth in Table 1 below.

TABLE 1

| | Minimum Range | | Moderate Rage | | Maximum Range | |
|---|---|---|---|---|---|---|
| Tilt | <15 | degrees | 15-30 | degrees | >30 | degrees |
| Recline | <110 | degrees | 110-130 | degrees | >130 | degrees |
| Leg rests | <110 | degrees | 110-130 | degrees | >130 | degrees |
| Seat Height | <2 | inches | 2-4 | inches | >4 | inches |

One may, for example, track the number of times the user places a wheelchair seat or a leg rest in the positions or ranges of positions described above during a period of time such as a day. A minimum required period of time (for example, 10 second and/or 30 seconds) in a certain position may be established in determining a number of times a positions is set. Moreover the duration of time in a certain position may be tracked by, for example, tracking the amount of time the user in in the chair and the amount of time the user is positioned within the above-defined (or other defined) positions.

Because system 10 may include telephone connectivity as, for example, provided by a personal communication device (for example, a cell phone/smartphone), system 10 is readily used as a component of, for example, a tele-health system or tele-rehab system. In that regard, as described above, data can be readily and easily communicated to clinicians. Long term health and/or recovery may, for example, be monitored. Data may, for example, be uploaded to a cloud-based system (for example, to a drop box) or via email. System 10 may, for example, provide for modifiable settings or parameters (for example, time and frequency) for email transmission or data upload.

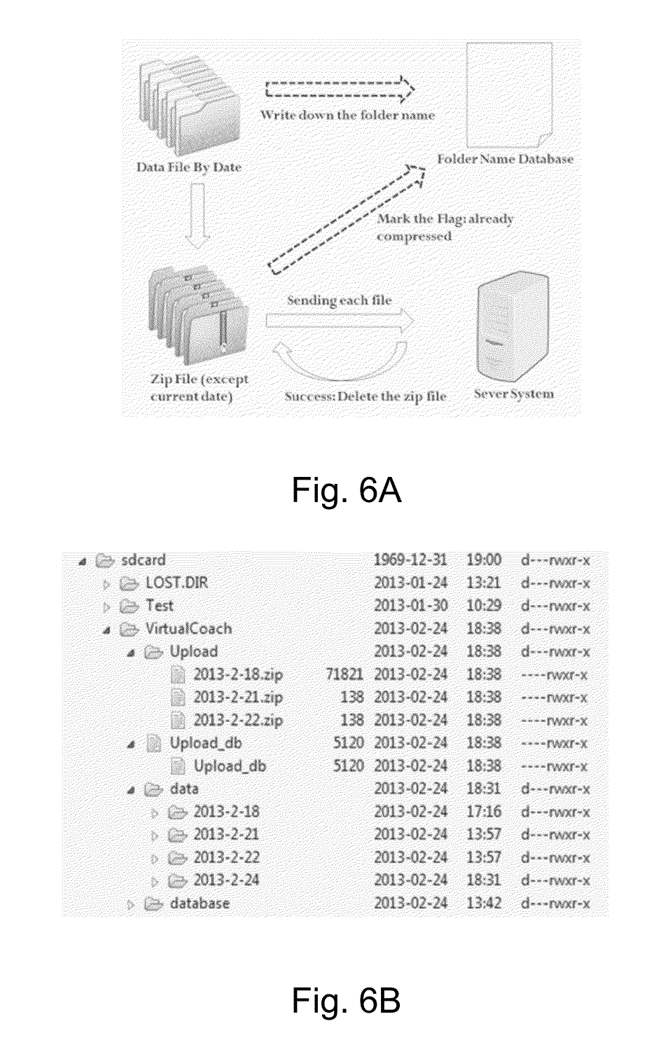

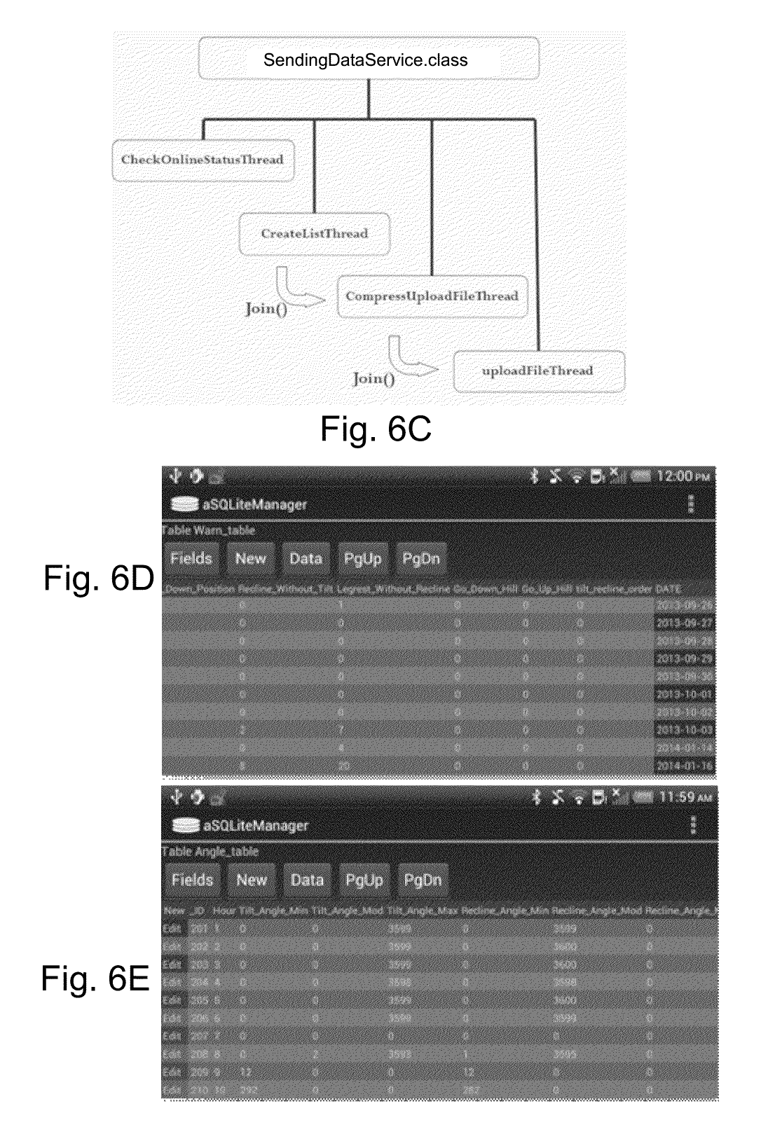

As, for example, illustrated in FIGS. 6A through 6C, in a number of representative embodiments, the first app or background service saves the seating functions usage data (via files in the data folder) by date in the SD card of smartphone 100. The sending service (of the background service or application) may, for example, first record all the data into a database (Upload_db file in the FIG. 6B) ordered by the file folder name. Second, the background service may compress all the data folders into compressed file format (for example, a ZIP archive file format). If a file compression process is completed, the background service may, for example, mark the specific file folder as “compression complete” in the database, so the program will be able to identify which data folder has been compressed already. In a third step, the background service may, for example, move all the compressed files into uploading folder (Upload folder in the FIG. 6B) and uploads files one by one. If the uploading process of a certain compressed file is complete, the service may, for example, delete this file, so the background service can identify which files are still waiting for uploading into a server. Sending raw or processed data to a remote server and/or other remote system allows, for example, data from multiple users to be investigated and analyzed

FIG. 6C illustrates a representative embodiment of a flowchart for a data saving/sending algorithm of the background service for the Java programming language. The illustrated program/algorithm uses Java class files, which are files containing a Java bytecode which can be executed on the Java Virtual Machine (JVM). As illustrated in FIG. 6C, the SendngDataService class registers a task which uploads the data files at specified times/frequencies in, for example, the ANDROID system. The class creates several threads to complete this uploading process task. The checkOnlineStatusThread checks if a network (for example, Wi-Fi or 3G/4G) is available. If a network is available, the createListThread records data into a database. If the createListThread finishes, it will start the CompressUploadFileThread by calling “join( )” function. CompressUploadFileThread will start to compress data files and move them into Upload folder, waiting for uploading. The next action/algorithm is uploadFileThread which uploads the compressed data into the server.

FIG. 6D illustrates a representative embodiment of a portion of a database in which data of reminders/warnings are recorded. The background service may, for example, record the type of reminders and how many pressure relief reminders that the users get within a day into a database system. FIG. 6E illustrates a representative embodiment of a portion of a database in which various positional angles are recorded as described above. System 10 may analyze the time that users stay in different angle position real time and save this information into the database system as described above.

Power wheelchairs such as wheelchair 500 may, for example, have an onboard control system/computer system to help with or to fully effect functionality as described herein. The control system may, for example, be used in controlling the motion of the wheelchair and the positions of various powered seating functions. FIG. 4 schematically illustrates a control system 550 of wheelchair 500 which includes a processor system including one or processors or controllers such as one or more microprocessors or microcontrollers 560 in operative connection with a memory system 564. In a number of embodiments, control system 550 may be altered to include or be in operative connection with a communication system 566 which provides, for example, cellular telephone connectivity, cellular internet access and/or radio-band internet access/WiFi and a user interface system 568 (including, for example, visual, audio and/or tactile feedback/input systems as known in the computer arts). Control system 550 may also include or be in communication with a sensor system including one or more sensors embedded in wheelchair 500. For example, counters 570, 572 and 574 may be provided to track data relevant to seat tilt, backrest recline, and leg rest elevation, respectively. In currently available wheelchairs systems, such counters are not used to output a profile of wheelchair setup, but may, for example, be used to measure stability and to slow the speed of a wheelchair in case of an instability. Also, various positions may be remembered to allow a user to quickly return to a preset or predetermined position (similar to the functionality of presets available on some powered car seats). In a number of embodiments hereof incorporating a personal communication device such as smartphone 100, the electronics/sensor interface system of smartphone interface 20 are placed in communicative connection with processor or controller 560 and/or sensors/counters 570, 572 and 574. In such an embodiment, accelerometers 60, 62, and 64 are not required. Algorithms may, for example, be provided to interpret the data from processor or controller 560 for use in system 10 (for example, to translate the data into profiles providing seat tilt, backrest recline, leg rest elevation).

System 10 may, for example, be operatively or communicatively connected to or integrated with wheelchair controller 560 to receive signals from controller 560 (including, but not limited to, sensors interfaced with controller 560), and/or to send signals/commands to controller 560. System 10 may, for example, be started from controller 560, when wheelchair 500 is activated or powered-up. Powering down wheelchair 500 may, for example, suspend system 10. The signals between controller 560 and components of system 10 may be analog or digital (via, for example, serial, parallel, CAN bus, RS-232, USB). Controller 560 and components of system 10 may, for example, be connected via a direct “hardwire” connection or wirelessly (e.g. via BLUETOOTH or WiFi). Data may, for example, be transmitted in various digital formats or analog (via an interface board). Software/algorithms of system 10 may, for example, convert sensor data from controller 560 to variables within the code to assist in coaching.

In a number of embodiments, system 10 may, for example, provide signals to controller 560 to effect a change in a seating function position. For example, a seat change that is determined to be important or critical (based, for example, upon predetermined rules) may be automatically performed via controller 560 upon receipt of an appropriate signal from system 10. For some users, seating function position changes as described herein may be partially of fully automated under certain, predetermined circumstances.

Moreover, one or more sensors of a sensor system 109 typically provided on smartphones such as an accelerometer, a gyrometer/gyroscope and/or a GPS system (represented collectively and schematically as sensor system 109 in FIGS. 2 and 3) may be used to measure the tilt or inclination of wheelchair 500, thereby obviating the need for accelerometer 66 as well as location of the wheelchair. IMU may, for example, be used to sensor vibration and remind users at risk for whole-body vibration injury.

In a number of representative embodiments, two applications or apps, as discussed above, were run on an ANDROID smartphone to collect the sensor data and display information to the user. The first or data collection application ran as a background program which is called a service or background service in the ANDROID system. In a number of embodiments, the background service keeps operating (for example, (periodically) requesting microcontroller board 56 to send data from accelerometers 60, 62, 64 and 66 (or from sensors 570, 572, 574 and 130) to smartphone 100) regardless of other operating functions of smartphone 100. In that regard, the background service continues to request data from the microcontroller 50 as an independent thread in the smartphone without affecting other smartphone functions or being affected by other functions. Even when the Smartphone is running other applications such as a web browser, social media sites such as FACEBOOK® and so on, system 10 monitors seating function usage at all times. Once the background service obtains the data, the data is broadcasted within system 10 and other applications are able to access the data. The background service may, for example, be able to detect the USB connection of smartphone 100 with microcontroller board 56 (via connector 30) or a wireless connection therebetween. Once it detects the USB (or other) connection, the service starts to record the data into, for example, a memory system of smartphone 100 such as an SD card. Based upon the measured data, system 10 may monitor the PSF usages and give reminders to the user if needed (as determined by system 10). As described above, in a number of embodiments, the second application supplies information to provide user coaching in system 10, and includes, for example, functionality to display seating function angle, provide user performance feedback, and display general information menu such as user manual. The user may interact with the second application and obtain information about PSFs and system 10.

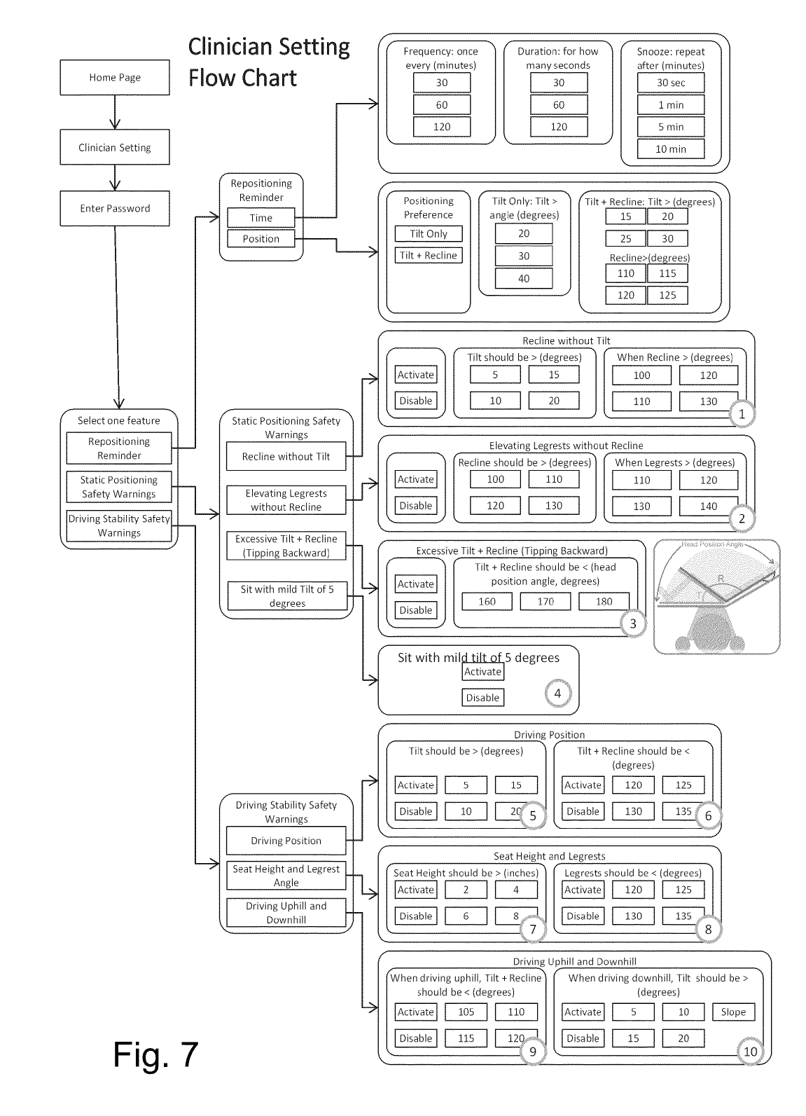

As described above, the background service monitors the seating function usage at all time while there is communicative connection between smartphone 100 and the sensor interface system. According to a clinicians recommendation (for example, determination and form of reminders may be customized), the background service may, for example, provide reminders to the user by using text messages or pop-up dialog to remind the user to adjust his/her seating function (as, for example, programmed by a clinician). FIG. 7 illustrates a representative embodiment of a flow chart for inputting clinician-determined settings in system 10. The background service may also remind the user to perform pressure relief within prescribed periods of time. For example, by clicking these reminder messages, the service may lead the users to an adjustment instruction screen (set forth on display 110), where the users can follow the instructions to adjust their seating functions properly. System 10 may alternatively perform the adjustment for the user (for example, upon acceptance of a proposed adjustment by the user).

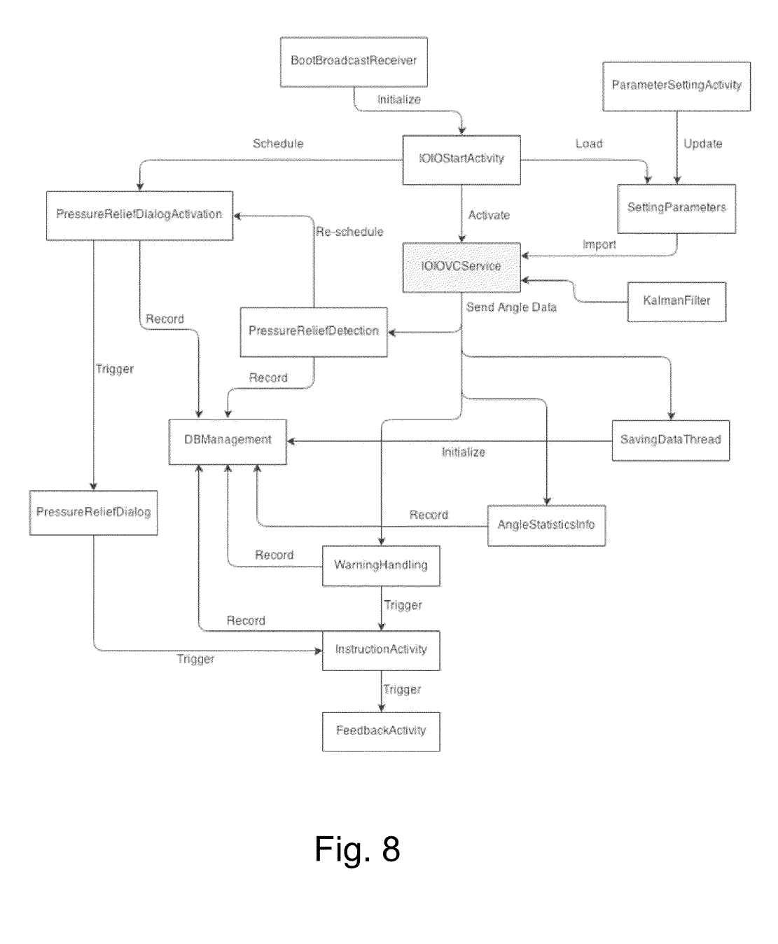

FIG. 8 illustrates a representative embodiment of an overall flowchart for the background service for the Java programming language. As clear to one skilled in the art, the programming of the systems hereof may be accomplished in other manners. In the illustrated embodiments, the program uses Java class files which can be executed on the Java Virtual Machine (JVM). Further explanation of the Java class files for the flowchart of FIG. 8 is set forth below. The AngleStatisticsInfo.java class file provides a function to calculate the duration that a seating function angle stays in different angle level (for example, minimum, moderate and maximum as described above). It provides a function to define the angle boundaries for calculation. Also, it provides a function to communicate with, for example, an SQLite® database (downloadable computer software for creating searchable databases of information and data, available from Hipp, Wyrick & Company of Charlotte, N.C.) to record the duration into database. The BootBroadcastReceiver.java class file activates the virtual seating coach app when, for example, the smartphone boots up. This class file extends the BroadcastReceiver class file to receive the system information when the smartphone boots up. Once the class file gets the bootup information from the system, it initializes IOIOStartActivity to start the background service (IOIOVCService). The DBManagement.java class file includes all the functions for database operations (for example, create, open, close, update, delete, query, insert, etc.) in, for example, the SQLITE database. The functions in this class file may, for example, be called, when recording a safety warning, a repositioning reminder, the duration of seating function angle staying in different angle level if needed.

The FeedbackActivity.java class file creates an activity to, for example, show a “Good Job” image on the smartphone screen to a user, when the user follows the instruction to adjust the seating function successfully or performs an effective repositioning exercise. The InstructionActivity.java class file create an activity for displaying the instruction screen to the users. According to different safety warning messages or repositioning reminders, the screen of the activity may display the description of the warning, steps to adjust seating function, and an angle bar indicating the angle level to which the seating function needs to be adjusted.

The IOIOStartActivity.java class file is called by the BootBroadcastReceiver.java class file. In a number of embodiments, this activity does not create a display on the screen. In a number of embodiments, this class (1) initializes the IOIOVCService.java class file, (2) loads the parameters of safety warning and repositioning reminder from SharedPreferences through the SettingParameters.java class file and (3) schedules the repositioning reminders through the PressureReliefDialogActivation.java class file. The OIOVCService.java class file is the kernel class in the VCIOIOStartServce app. This class file creates a service in the background of the system of, for example, a smartphone (for example, an ANDROID system), which communicates with the IOIO board to get the accelerometer sensor data. The protocol is through IOIO library (see, for example, IOIOLib Basics and other information available at github.com) to communicate with the IOIO board. IOIOLib is a collection of libraries, for ANDROID and for the PC, which enable an application to control the IOIO board. This class file outputs seating functions information (for example, angle information) via static values and using bundle object, so a seating functions value may be used in different classes within the IOIOVCStartService app or other external apps. All other classes such as AngleStatisticsInfo.java class file, the SavingDataThread.java class file, and the WarningHandling.java class file are implemented into this class file to extend the functions of VCIOIOStartService app.

The KalmanFilter.java class file creates a filter object which uses a Kalman filter and moving average to filter the seating functions angle data. The ParameterSettingActivity.java class file creates a system activity to display all the parameters of safety warning and repositioning exercise setting, which can allow the clinicians to customize the coach program to different users based on their living situation. The PressureReliefDetection.java class file detects whether the users perform the repositioning exercise ahead of the time a reminder issues. If the users perform the repositioning exercise before the reminder issues, it will automatically disable the reminder and reset the reminder for the next interval. This class file also records the data into the database.

The PressureReliefDialog.java class file creates a system activity to display the repositioning exercise reminder on the top of, for example, a smartphone screen to remind the users to perform a repositioning exercise. It may, for example, show three option buttons to the users, OK, SNOOZE and CANCEL. If the users click OK button, the program will enter the InstructionActivity.java class file. For the SNOOZE button, the reminder will be snoozed and will issue again after, for example, 2 minutes (the time interval may be customized). The CANCEL button will postpone the reminder to the next interval. The reminder may, for example, stay on the screen for a period of time such as 40 seconds and automatically be snoozed. The nature of the sound of the reminders may, for example, depend on how the users set the sound mode of their device. For example, if the users change a smartphone device into a vibration mode, the repositioning reminder may be provided (at least in part) in the vibration mode.

The PressureReliefDialogActivation.java class file creates an system activity to detect USB connection status and running status of the IOIOVCService.java class file. If the USB is connected and the IOIOVCService is running, the class file will activate the PressureReliefDialog.java class file to generate the repositioning exercise dialog on the screen. Also, it will write a record of repositioning reminder in the database as well as set up the next repositioning exercise reminder.

The SavingDataThread.java class file creates a thread when the IOIOVCService.java starts running. The purpose of this thread is saving the seating functions angle into a file in a memory system or modules such as an SD card. If the service stops, it has the interruption mechanism to stop the thread. When the service backs up, it will create a new thread to perform the saving data task. This thread also controls the open and close of the database through creating a DBManagement.java object.

The SettingParameters.java class file communicates with the SharedPreferences for saving and retrieving the parameter setting for the safety warning and repositioning exercise. The setting may, for example, be modified via the ParameterSettingActivity.java class file.

The WarningHandling.java class file includes three classes for managing all safety warning events, which include: WarningManager.class, WarningPackage.class and WarningPackageCenter.class. WarningManager.class gets seating function angle from IOIOVCService.java class file and checks all the safety warning. The safety warnings may, for example, include: (1) Seat Without Tilt warning (users need to sit on the powered wheelchair with slight tilt angle); (2) Head Down Position (a reminder to warn the users that their head should not be lower than their body, when using tilt and recline functions together); (3) Recline Without Tilt (when using recline function only above certain angle, the users need to tilt their wheelchair to prevent their body from sliding down on the wheelchair); (4) Leg rest Without Recline (when using leg rest function only above certain angle, the users need to recline their wheelchair to prevent their hamstring from over stretching, leading to their body sliding on the wheelchair); (5) Go Down Hill (while driving down slope, the users need to tilt their wheelchair to prevent their body from sliding forward on the wheelchair); (6) Go Up Hill (while driving up slope, the users need to tilt back (with relative small tilt angle) to prevent the wheelchair from tipping over); and (7) Tilt Recline Order (when the users are moving back their tilt and recline angle from a relative large angle, the users need to change the recline angle first and then the tilt to prevent their body from sliding down on the wheelchair).

WarningPackage.class generates a WarningPackage object which includes the safety warning type, time and description when any one of the above safety warnings triggers. The WarningPackage object will then send to the WarningPackageCenter.class, so the application may generate reminders to the users. WarningPackageCenter.class, after receiving the WarningPackage object, handles the warning based on the type of WarningPackage object, and triggers the notification system to generate the reminders.

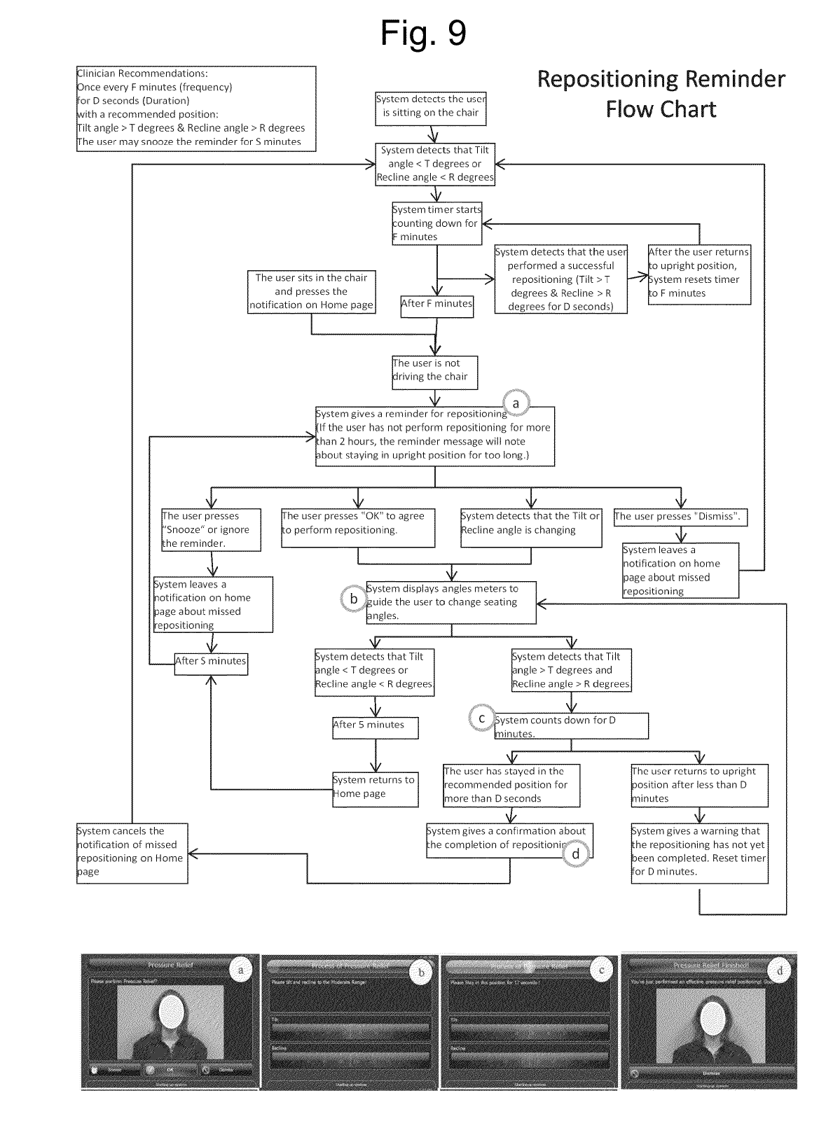

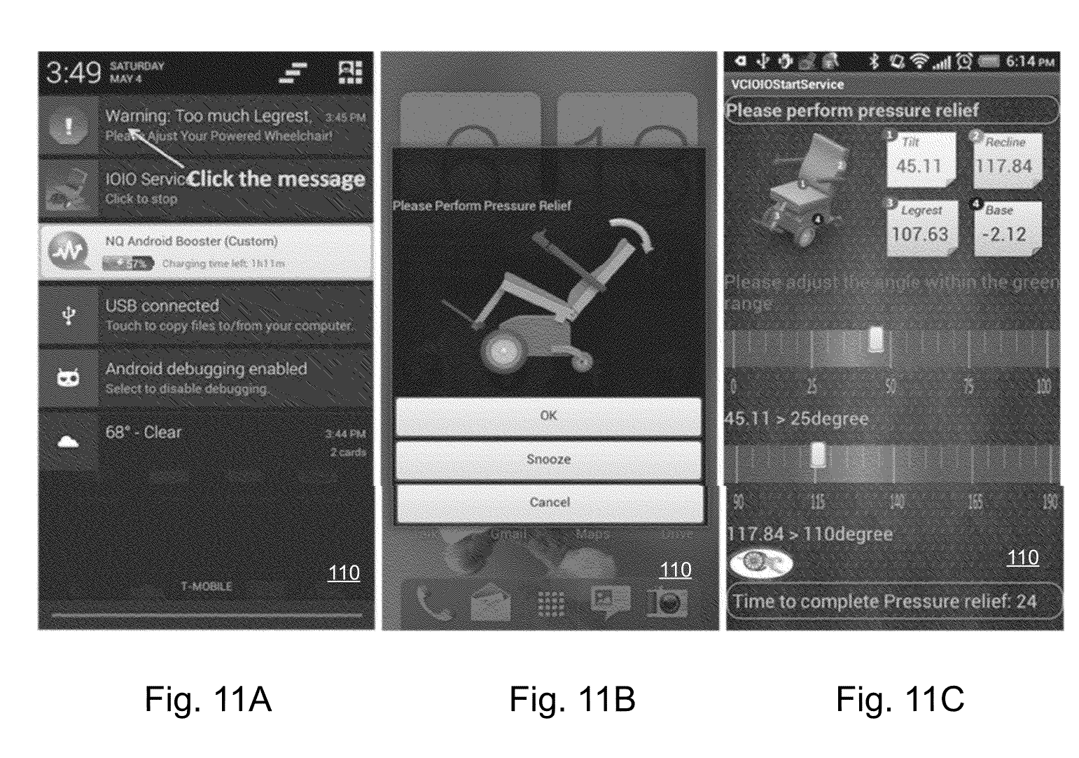

FIG. 9 illustrates a representative embodiment of a flow chart of a methodology for inputting settings or parameters for the repositioning reminders. In the illustrated embodiment, system 10 provides a reminder for repositioning if, for example, the user has not performed repositioning for more than a predetermined period of time. The reminder message may, for example, note that the user has stayed in an upright position for too long. The user may, for example, be provided a choice of ignoring/delaying the suggest change or effecting the change. If the user decides to effect the change, system 10 may, for example, display angle setting and/or illustrative angle meters (see, for example, FIGS. 11C, 12A and 13, which are discussed further below) to guide the user in changing seating settings. System 10 may also monitor the state of the relevant seating function variables to ensure that the change set forth in a reminder has been made. As set forth above, data regarding various action(s) taken or inaction can be saved to the memory system of smartphone 100 and/or uploaded to a server.

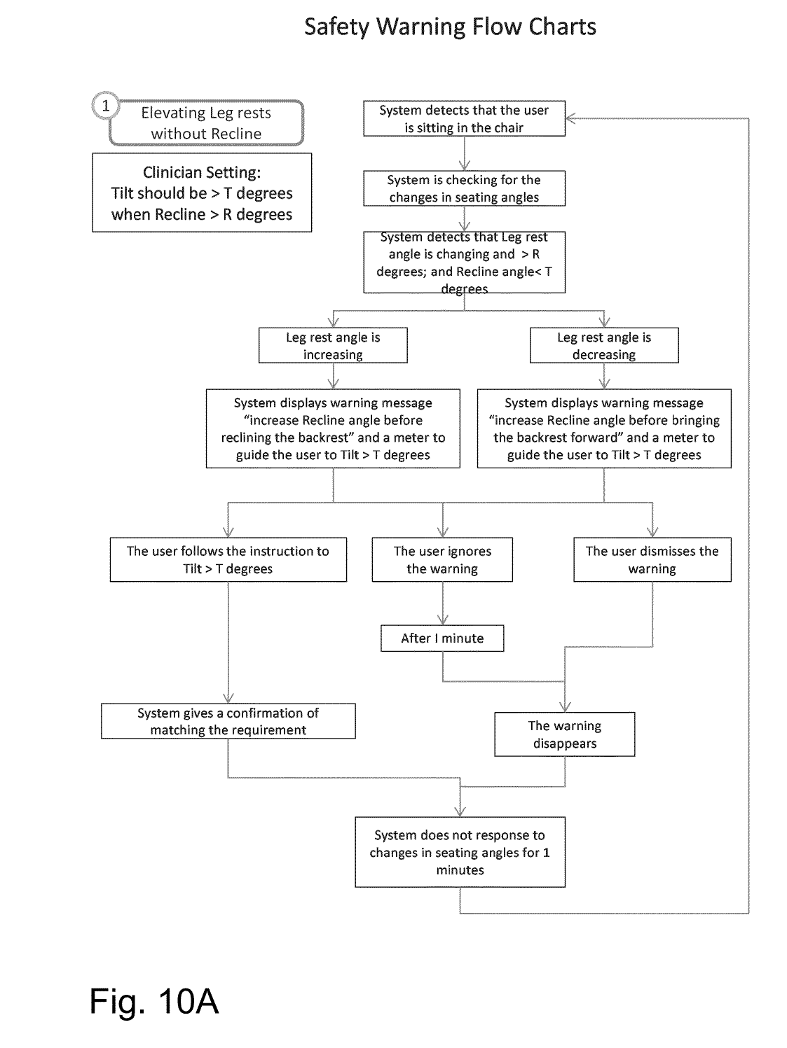

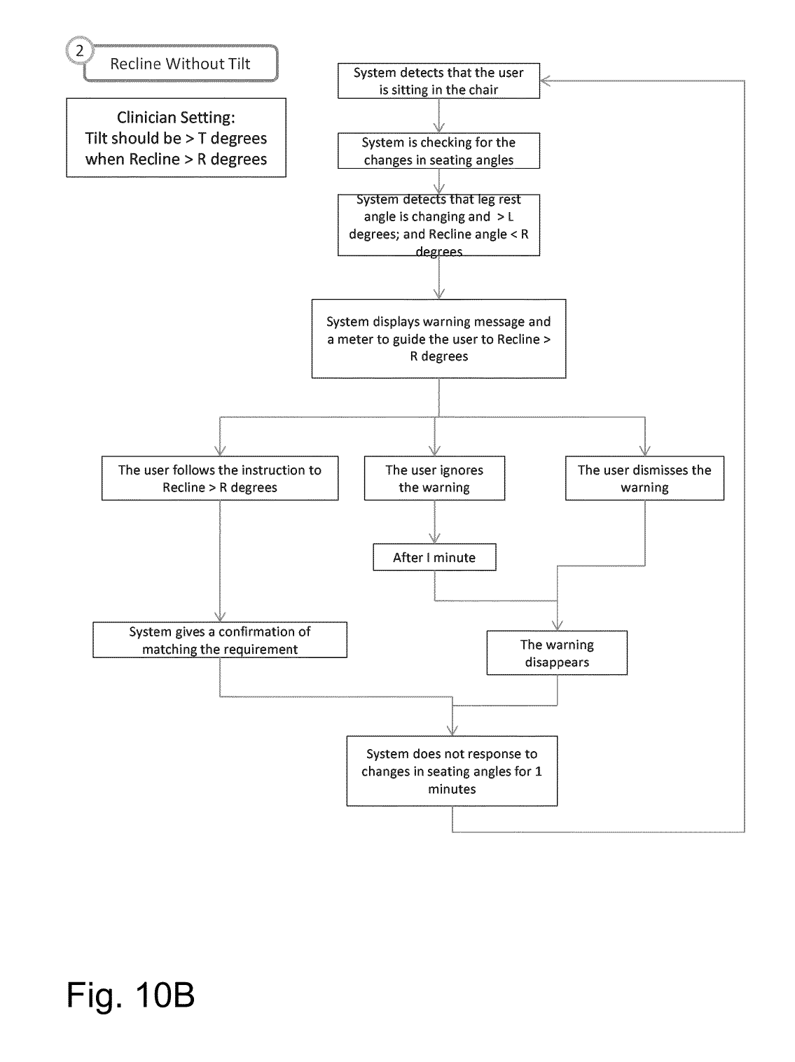

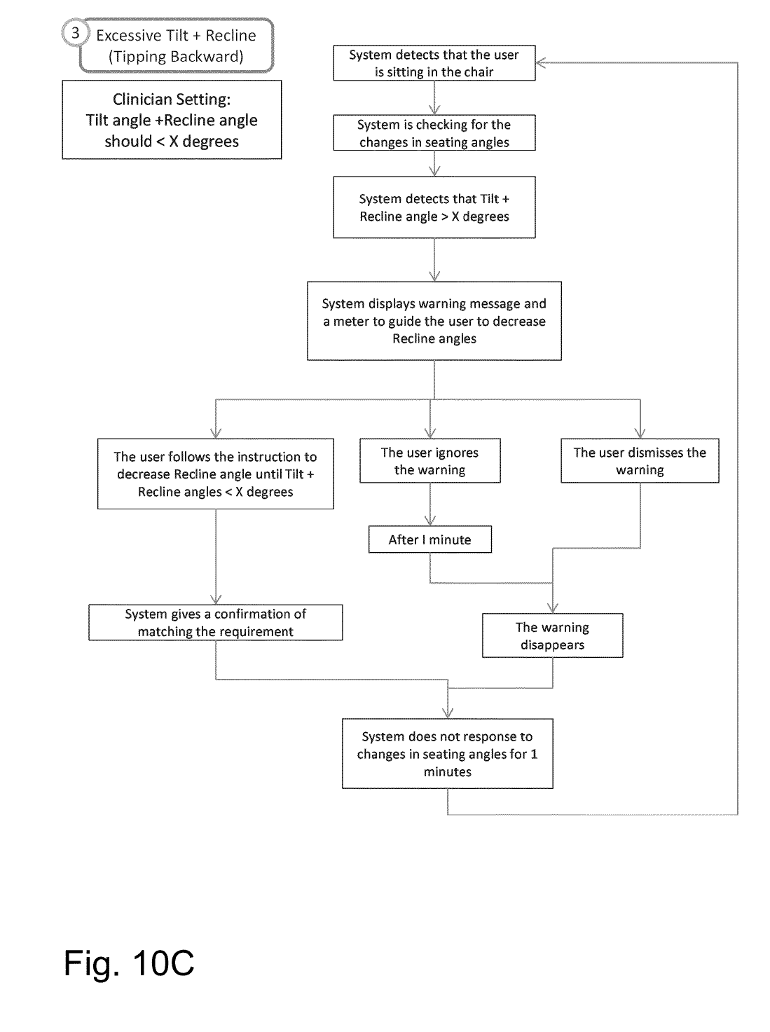

FIG. 10A through 10C illustrate representative examples of methodologies for determining the need for and setting forth instability warnings. In that regard, FIG. 10A illustrates an embodiment of a flow chart for determining the need for and setting forth safety warnings related to instability caused by certain leg rest angle/elevation settings without sufficient backrest recline angle. FIG. 10B illustrates an embodiment of a flow chart for determining the need for and setting forth safety warnings related to instability caused by certain backrest recline angle settings without sufficient tilt angle. FIG. 10C illustrates an embodiment of a flow chart for detecting the need for and setting forth safety warnings related to instability caused by excessive backrest recline angle and tilt angle. The angle X in FIG. 10C may, for example, be provided as a function of the angle of inclination of the wheelchair.

FIG. 11A illustrates an embodiment of a screenshot of display 110 of smartphone 100 providing a reminder of required seating function usage to address excessive leg rest, while FIG. 11B illustrates an embodiment of a screenshot of display 110 providing a reminder of seating function usage to address pressure relief FIG. 11C illustrates an embodiment of a screenshot of display 110 providing a reminder of seating function usage to address pressure relief as well as instructions indicating how the user should adjust the user's powered wheelchair.

As described above for a number of representative embodiments, once smartphone 100 (with the apps described above installed thereon) connects to USB connector 30 on cradle 22 or otherwise comes into communicative connection with the sensor interface system of system 10, the first app may detect connection, automatically start working as a background service, and effect monitoring of seating functions (for the determining of circumstances/timing to deliver repositioning reminders and/or safety warnings). Once the connection of smartphone 100 has been detected, the background service may, for example, start to request the data from microcontroller 52, record the data into a file, and monitor the seating function usage. In a number of embodiments, the background service activated a file recording thread as described above which recorded the angle data with 1 Hz sampling rate into text files. The text files may, for example, be saved into SD card and/or other memory system of smartphone 100. The first app or background service may, for example, continue to run if the wheelchair is powered down, if the phone is unplugged, if another app is activated (for example, a web browser etc.) or if a phone call is initiated. Continuation of the first app in such situations prevents frequent restarts and ensures that system 10 monitors seating function usage at all times.

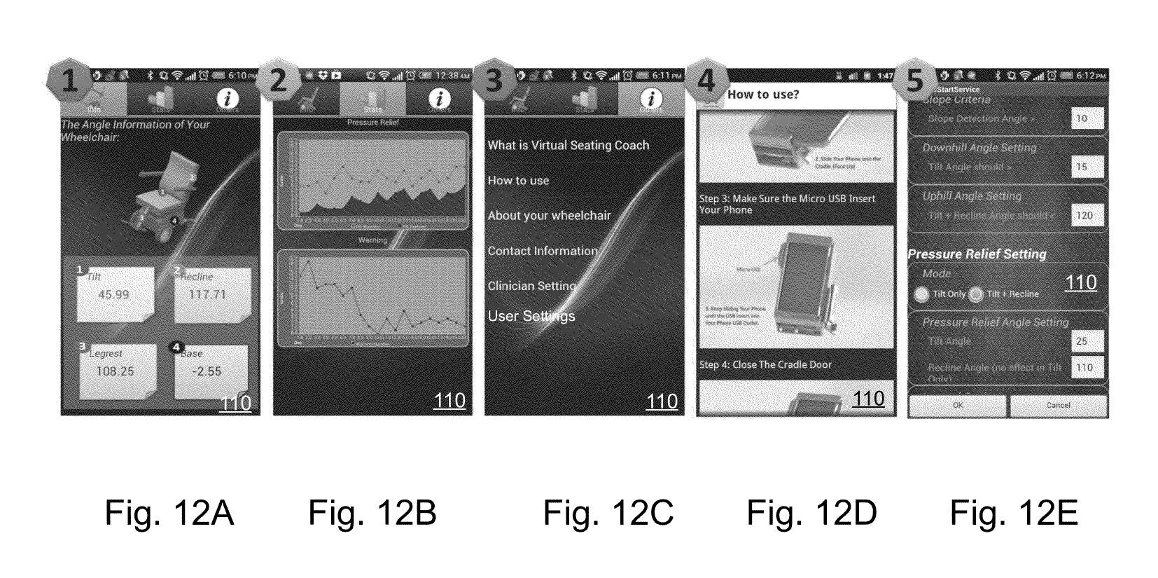

As described above, the second app provides information to the user which may, for example, include displaying function angle. In that regard, the application may, for example, show the angle information based on the tilt angle of the accelerometers so that the user can clearly and easily read the tilt, recline, leg rest, and wheelchair base angles. FIG. 12A illustrates an embodiment of a screenshot for display 110 providing information regarding the current states of a setup for wheelchair 500 as measured by accelerometers 60, 62, 64 and 66 (or by sensors 570, 572, 574 and 130).

The second app may also provide for user performance feedback: Users may, for example, be provided with information to review the user's progress of using seating functions. A goal is to increase the compliance with performing positioning as directed and decrease the number of seating function usage warning. FIG. 12B, for example, illustrates an embodiment of a screenshot for display 110 providing recorded data regarding pressure relief and warnings over a period of time (20 days).

The second app may, for example, provide users a brief introduction to system 10, information on seating functions, and step-by-step guidance on how to use system 10. Information provided by the apps may, for example, be provided in a menu driven fashion. FIG. 12C illustrates an embodiment of a screenshot for display 110 providing a menu for accessing various information and/or functions. FIG. 12D illustrates an embodiment of a screenshot for display 110 of a portion of a user's manual providing information regarding use of system 10, including smartphone interface 20. The second app may, for example, include a clinician setting menu as well as a user settings menu which may be used to customize the reminder settings for different users. In that regard, FIG. 12E illustrates an embodiment of a screenshot for a display of the smartphone providing information regarding settings for the system hereof.

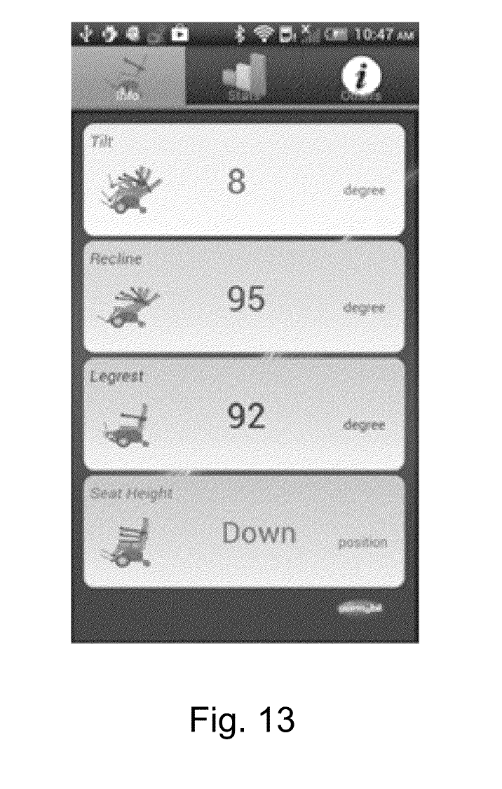

FIG. 13 illustrates another representative embodiment of a screenshot for providing seating functions to a user. Similar to FIG. 12A, the screenshot of FIG. 13 shows angle information based on, for example, the tilt angle of the accelerometers. The user can clearly and easily read the tilt, recline, leg rest, seat elevation or height, wheelchair base angles etc. and have a direct angle (or other) value feedback when changing their seating function parameters. Users may, for example, know that a 30 degree tilt angle can decrease the pressure on their buttocks significantly, but they may not sense the angle value when tilting their chair. Providing such feedback to users can make sure that users can adjust their powered wheelchair appropriately. The embodiment of the display interface of FIG. 13 provides an enlarged text size and clarifies the angle information (for example, via representative images).

Further explanation of the Java class files for the interfaces set forth in FIGS. 12A through 13 is set forth below. In a number of embodiments, a VirtualSeatingCoach.java class file is the main class for the Virtual Seating Coach interface app. This class file creates an activity which loads Tab1.java, Tab2.java and Tab3.java class file. Also, it creates the navigation bar for selecting the three taps on the top. The Tab1.java class file creates the first tab display as set forth in FIG. 12A. In this display, one powered wheelchair with numbers indicating the seating function is on the top half of the screen. The lower portion of the display illustrates the seating function angle information including tilt, recline, leg rest and base. The Tab2.java class file creates two figures by calling a Bargraph.class file, which display the compliance of performing repositioning exercise and the number of safety warning a user gets every day. The Bargraph.java class file draws the figures as described above (see, for example, FIG. 12B). In, for example, and ANDROID operating system, the class file may use AndroidPlot library to draw the figures. AndroidPlot is an API for creating dynamic and static charts within an ADROID application. The Tab3.java class file creates a list of information about the virtual seating coach app to users. This class calls the ListViewContent.class to create the list. As, for example, illustrated in FIG. 12B, the information may include: “What is the virtual seating coach”, “How to use”, “About your wheelchair”, and “Contact information” section. It also has an option called “Clinician setting”, which triggers the ParameterSettingActivity.class in Virtual Seating Coach background service.

The DBManagement.java class file may be the same class file as the DBManagement.java file in Virtual Seating Coach background service. The class file includes all the functions for database operations (create, open, close, update, delete, query, insert, etc.) in, for example, an SQLite database. The functions in this class will be called, when recording the safety warning, repositioning reminder, the duration of seating function angle staying in different angle level if needed.

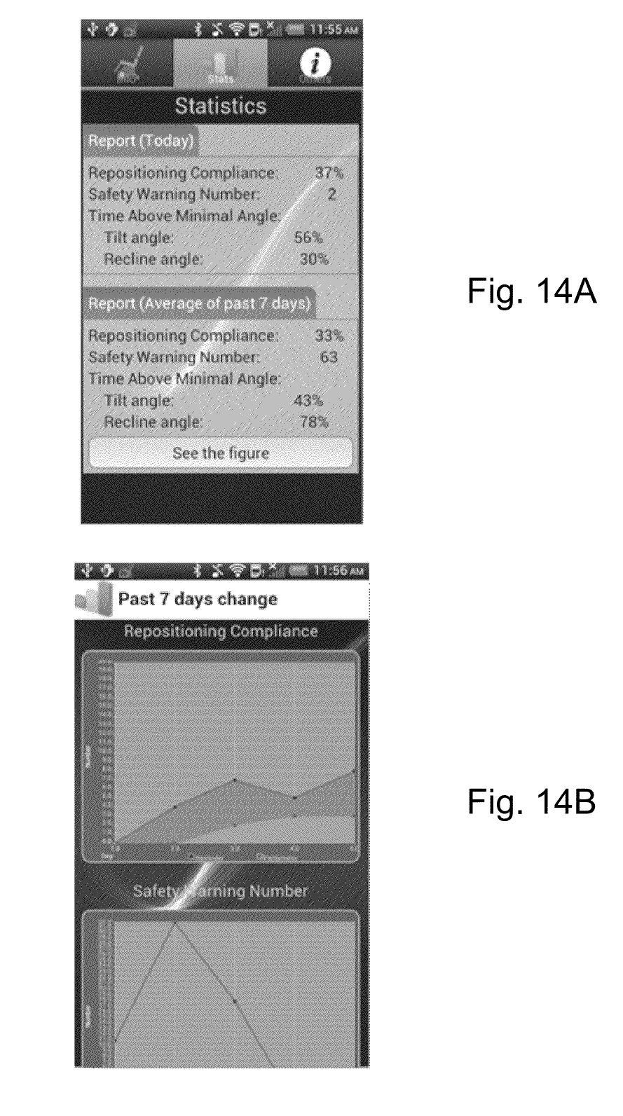

As, for example, illustrated in the representative embodiment of FIGS. 14A and 14B, system 10 can, for example, provide a summary of seating functions usage by analyzing the data from one or more databases created as described above. Users can review their progress of using seating functions. As described above, a representative goal is to increase the compliance with performing repositioning exercise as directed and thereby decrease the number of seating function usage warning. Also, the information encourages users to stay in moderate to max tilt and recline angle to elevate the pressure on their back and buttocks.

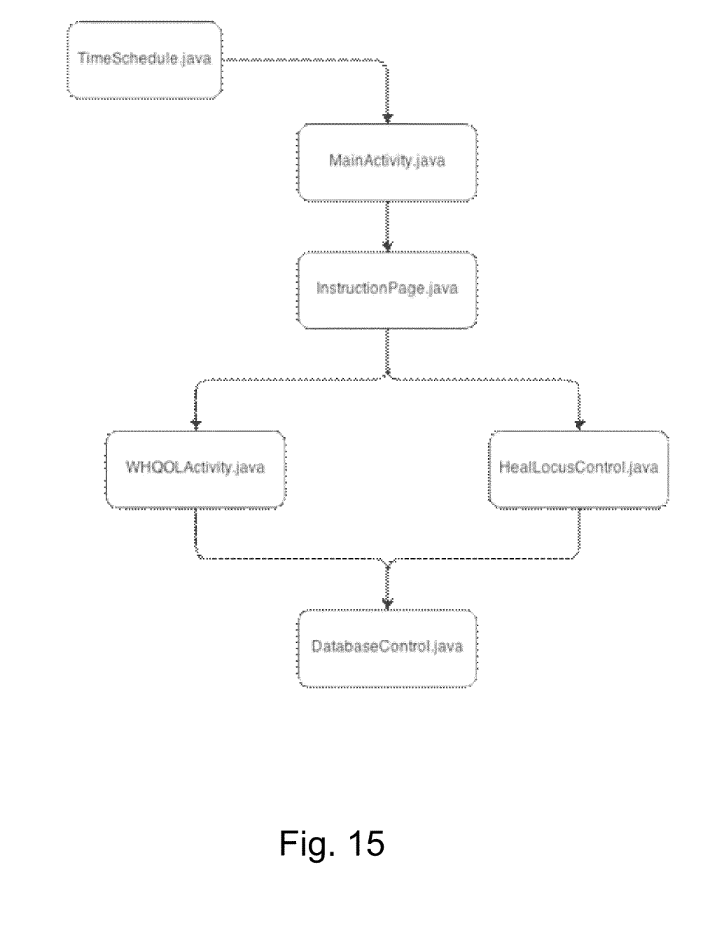

System 10 can also be used to administer questionnaires. Data from such questionnaires can be transmitted to one or more remote systems. For example, such questionnaires may be used to evaluate the efficacy of system 10 in helping to prevent sores and/or other complications, hospitalization, falls/tips etc. Such ground source data may for example be collected by causing system 10 to set forth use questions on some periodic basis. Data can be collected on both compliance and impact. Manufacturers, users, clinicians etc. can use collected data to determine if use of, for example, PFSs is compliant and to determine the impact of use of PFSs and system 10. Aspects of system 10, such as parameters, setting and/or interactive displays can be modified in view of collected data. FIG. 15 illustrates a representative embodiment of a questionnaire app (in the Java programming language) of system 10 developed to gather, for example, users' general health information, system usage etc. The Java class files associated with the questionnaire app are summarized below.

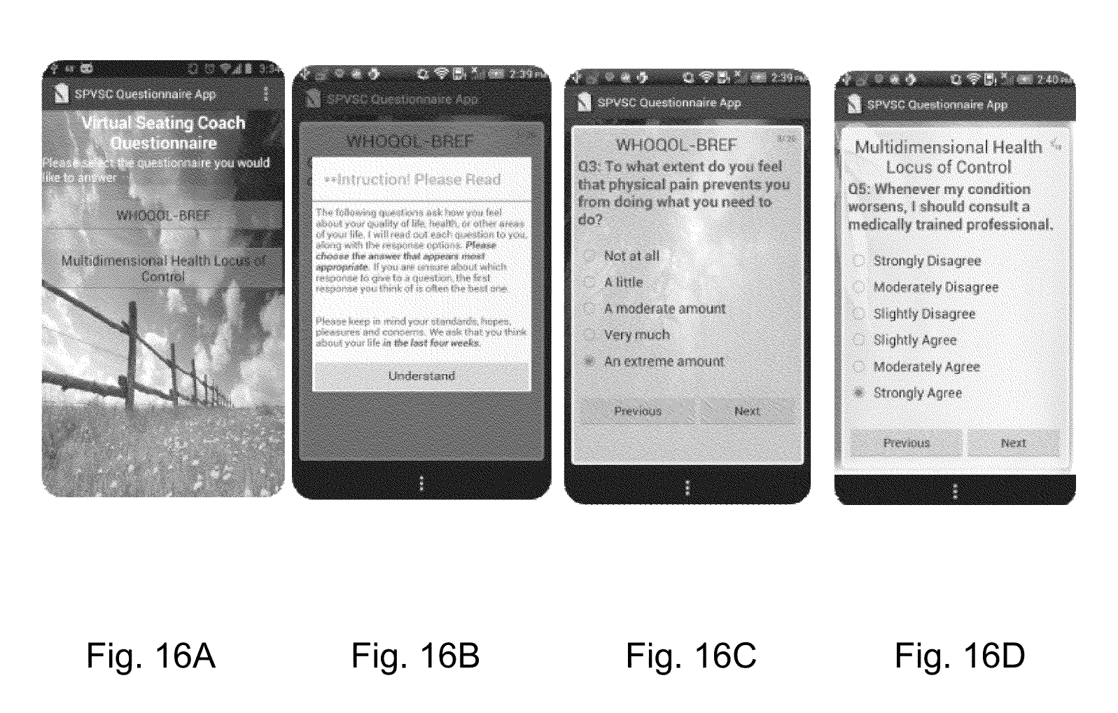

FIGS. 16A through 16D provide representative examples of screenshots for a questionnaire interface. In that regard, FIG. 16A illustrates an embodiment of a display via which a user can select to answer a questionnaire. FIG. 16B illustrates an embodiment of a display of instructions for answering a questionnaire. FIG. 16C illustrates an embodiment of a display providing an example of a question posed in a questionnaire and choices for answers. FIG. 16D illustrates an embodiment of a display providing an example of a question posed in a multidimensional health locus of control questionnaire and choices for answers.

In a number of embodiments, a TimeSchedule.java class file controls the times and interval of the questionnaire app which reminds and displays the questionnaire to users. In the MainActivity.java class file, if the users choose to answer the survey, the app will display the available questionnaires to the users (see FIG. 16A). In this example, the app shows two questionnaire, WHQOL-Brief and Multidimensional health locus of control, to the users. The InstructionPage.java class file shows the instruction of answering the questionnaire (see FIG. 16B). The WHQOLActivity.java class file displays each question in the WHQOL-Brief to the users (see FIG. 16C). The HealthlocusControl.java class file displays each question in the Multidimensional health locus of control to the users (see FIG. 16D). The DatabaseControl.java class file handles the database used in operating system (for example, an SQLite database in ADROID operating system) which stores the answers of each question into database, so the researchers may track the users' situations.

In a number of embodiments, the questionnaire tool or app was used to assess wheelchair discomfort. In one embodiment, this portion of the questionnaire app included three sections. Section I provided general information about factors that directly affect discomfort in one's wheelchair. Section II included a number of statements related to discomfort and a number statements related to comfort. Those statements were rated on, for example, a seven-point Likert scale where 1 is “strongly disagree” and 7 is “strongly agree”. In Section III, seven body areas (back, neck, buttocks, legs, arms, feet, and hands) were rated for a degree of discomfort intensity on a scale of 0 (no discomfort) to 10 (severe discomfort).

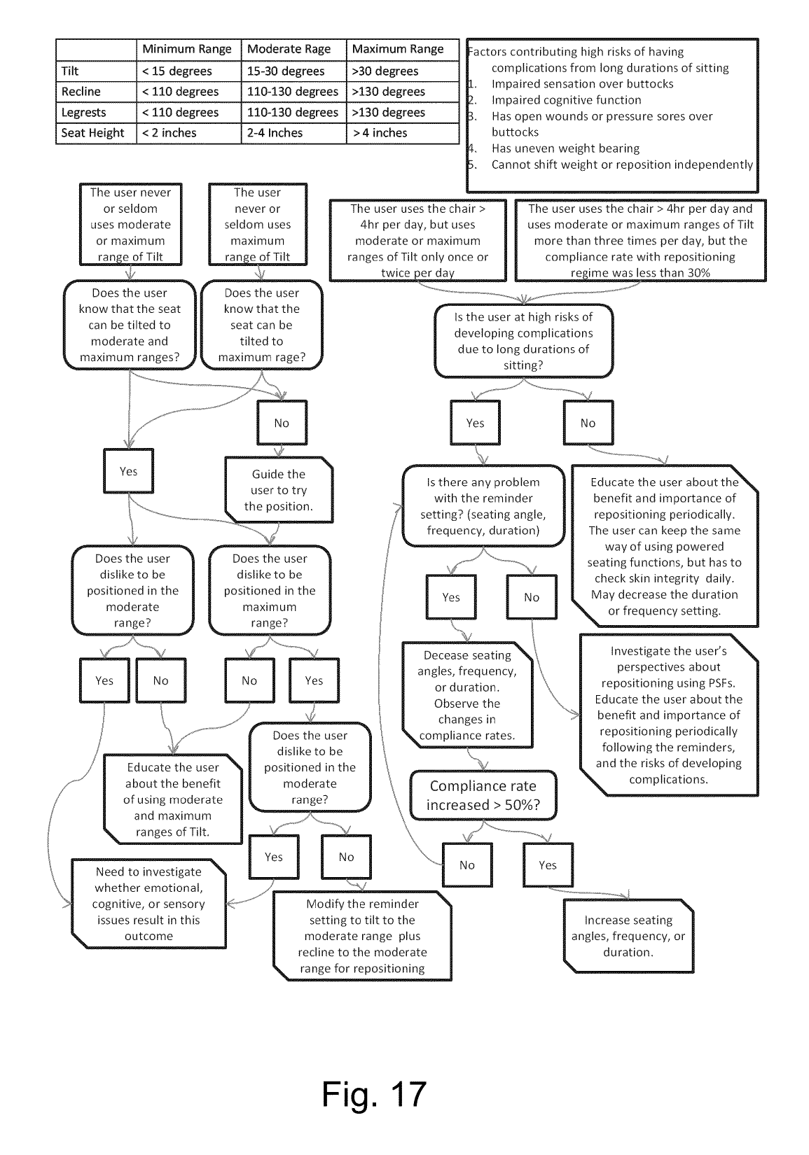

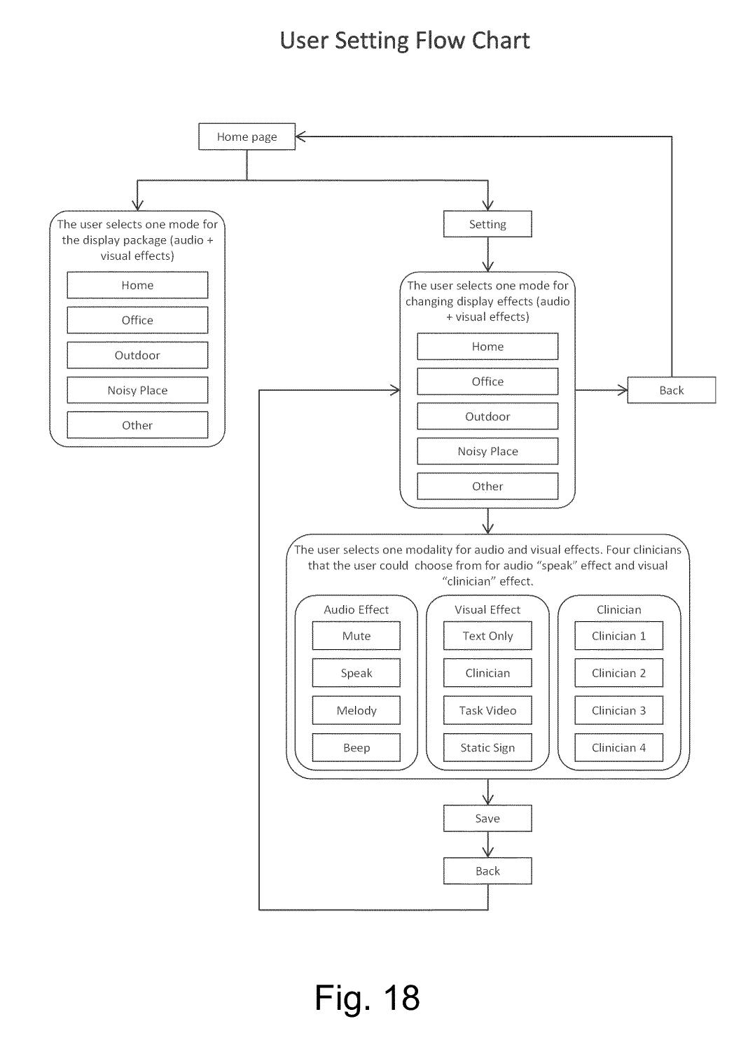

FIG. 17 illustrates a representative embodiment of a flow chart setting forth a methodology for setting and/or changing various user settings (for example, accessible from the menu provided in FIG. 12C. The user may, for example, set forth different modes for audio and/or visual effects for interaction with system 10. Moreover, the user may input data/settings for clinician/technician interaction with system 10.

Access to system 10 may, for example, be provided to individuals other than the wheelchair user via web page of via cloud-based communications. Amazon Elastic Compute Cloud (AMAZON EC2®, a, web services providing remote hosting and other services available from Amazon Technologies, Inc. of Reno, Nev.) may, for example, be used as a web service where the prototype. The data transmission between website portal and system 10 may, for example, be through SSH File Transfer Protocol (sFTP).

In one embodiment, variables selected to be presented via the website portal included (1) wheelchair occupancy, (2) compliance rates of performing repositioning exercises, (3) number of safety warnings, (4) frequency of using different seating functions, and (5) scores of Tool for Assessing Wheelchair discomfort (TAWC) questionnaire.

The webpage may present data from system 10 in many different formats. In a number of embodiments, the webpage presented the wheelchair occupancy, compliance rate and the distribution of the safety reminders. The webpage may, for example, allow a clinician to choose the time period that he/she wants to review for their clients. The wheelchair occupancy allows the clinicians to know the length of time that the users stay in their wheelchairs. If clinicians find that their clients do not use their wheelchairs frequently, they may communicate with their clients to see which factors cause them not to use their wheelchairs. For example, the wheelchair does not meet their requirements, their home environment is not wheelchair friendly, or other reasons. High compliance rates of performing repositioning exercises is encouraged for every wheelchair user because it decreases the likelihood of developing, for example, pressure ulcers as describe above. The data of compliance rates from system 10 may, for example, be analyzed to identify valuable correlations between, for example, compliance and improved health outcomes on a per-patient and/or multi-patient basis. The webpage may also present the number of safety reminders activated, which allows the clinicians to determine whether their clients might adjust their seating functions in an appropriate manner. Inappropriate adjustments might, for example, result in increased risk that users might slide out of their wheelchair or result in in a poor sitting posture in their wheelchair.

The webpage may also present data on the frequency of using PSFs (or manual seating functions). Wheelchair seating discomfort is a very common problem for wheelchair users. Because of motor and/or sensory impairments, powered wheelchair users may not be able to adjust their sitting posture as frequently as needed. Insufficient postural changes in their chair may be one reason causing wheelchair discomfort. For this reason, recording the frequency of using PSFs and score from a discomfort questionnaire as described above, may provide information to investigate the relationship between PSFs usage and wheelchair discomfort. In addition, answering discomfort related questions in the questionnaire app allows the users to let their clinicians know their conditions in the wheelchairs daily. The clinicians thereby have the opportunity to look into the issues the users may have and provide solutions to such issues.

Via web-based or cloud based communications between system 10 and, for example, a clinician, the clinician may be provided the ability to change guidelines or settings in system 10 remotely. System 10 may, for example, interact with various platforms such as the Interactive Mobile Health & Rehabilitation (iMHere) described, for example, in Parnianto, B. et al., “iMHere: A Novel nHealth System for Supporting Self-Care in Management of Complex and Chronic Conditions.” JMIR health and Uhealth 1 (2) (July 11): e10, doi:10.2196/mhealth.2391 (2013), to provide clinician communication. The iMHere platform provides clinician guided self-care to patients with chronic issues. The platform connects patient apps with a web-based clinician portal over a secure two-way Internet bridge. The user's medical records may, for example, be accessed and data from system 10 may be entered in such records. Moreover, the user's medical records can be used to change system 10.

The foregoing description and accompanying drawings set forth a number of representative embodiments at the present time. Various modifications, additions and alternative designs will, of course, become apparent to those skilled in the art in light of the foregoing teachings without departing from the scope hereof, which is indicated by the following claims rather than by the foregoing description. All changes and variations that fall within the meaning and range of equivalency of the claims are to be embraced within their scope.

What is claimed is:

1. A wheelchair system, comprising
a wheelchair comprising at least one adjustable seating function;
a sensor system in operative connection with the wheelchair comprising at least one of sensor to sense a position of the at least one adjustable seating function,
a processor system in operative connection with the sensor system,
a memory system in operative connection with the processor system,
a communication system in operative connection with the processor system, the communication system being adapted to wirelessly communicate with one or more remote systems;
a user interface system in operative connection with the processor system, and
at least one application stored on the memory system and executable by the processor system to provide information via the user interface system to a user of the wheelchair related to data from the sensor system to assist the user to adjust the position of at least one adjustable seating function in accordance with parameters stored in the memory system.

2. The wheelchair system of claim 1 comprising a plurality of adjustable seating functions, the sensor system comprising a plurality of sensors, each of the plurality of sensors being adapted to sense a position of at least one of the plurality of adjustable seating functions, the at least one application being executable to provide information to the user of the wheelchair related to the data from the sensor system to assist the user to adjust position of any one of the plurality of adjustable seating functions in accordance with the parameters stored in the memory system.

3. The wheelchair system of claim 2 wherein the at least one application is adapted to generate messages via the user interface system regarding the plurality of adjustable seating functions based at least in part upon the parameters stored in the memory.

4. The wheelchair system of claim 3 wherein the messages comprise at least one of reminders to the user via the user interface system to adjust the position of each of the plurality of adjustable seating functions and warnings to the user via the user interface system regarding the position of at least one of the plurality of adjustable seating functions.

5. The wheelchair system of claim 4 wherein the warnings are based at least in part upon one or more of the parameters stored in memory relating to the position of one of the plurality of adjustable seating functions relative to the position of another one of the plurality of adjustable seating functions, relating to the position of one of the plurality of seating functions relative to a measured orientation of the wheelchair, or relating to the position of one of the plurality of seating functions relative to a measured speed or acceleration of the wheelchair.

6. The wheelchair system of claim 5 wherein the at least one application is adapted to store data regarding the reminders, user action on the reminders, the warnings and user action on the warnings in the memory system.

7. The wheelchair system of claim 5 wherein the at least one application is adapted to transmit data regarding the reminders, user action on the reminders, the warnings, and user action on the warnings to at least one of the one or more remote systems via the communication system or to receive data from at least one of the one or more remote system to alter the parameters stored in the memory system.

8. The wheelchair system of claim 7 wherein one or more of the plurality of adjustable seating functions comprises at least one powered seating functions.

9. The wheelchair system of claim 7 wherein the one or more of the plurality of adjustable seating functions comprise angle of seat tilt, angle of backrest recline, leg rest elevation.

10. The wheelchair system of claim 7 wherein the user interface system comprises a display.

11. The wheelchair system of claim 7 wherein one or more of the generated messages are dependent upon at least one of a location of wheelchair, a condition of the environment of the wheelchair, or an activity in which the user is involved.

12. The wheelchair system of claim 11 wherein the sensor system further comprises at least one of a sensor to determine the location of the wheelchair, a sensor to determine the condition of the environment of the wheelchair, or a sensor to determine a variable related to the activity in which the user is involved.

13. The wheelchair system of claim 5 wherein the sensor system further comprises at least one of a sensor to measure orientation of the wheelchair, a sensor to measure speed of the wheelchair or a sensor to measure acceleration of the wheelchair.

14. The wheelchair system of claim 1 wherein the at least one application is further adapted to administer at least one questionnaire to a user.

15. The wheelchair system of claim 1 wherein the wheelchair is a powered wheelchair comprising a control system comprising a processor and the processor is a component of the processor system.

16. The wheelchair system of claim 4 wherein at least one processor of the processor system, at least one memory component of the memory system, at least one communication component of the communication system and at least one interface component of the interface system are provided by a personal communication device

17. The wheelchair system of claim 16 wherein the personal communication device is a smartphone or a tablet computer.

18. The wheelchair system of claim 16 further comprising a personal communication system interface operatively connected to the wheelchair and comprising a connector adapted to be placed in communicative connection with a cooperating connector of the personal communication device, the connector providing operative connection between the sensor system and the personal communication device.

19. The wheelchair system of claim 18 wherein the wheelchair is a powered wheelchair further comprising a control system in operative connection with one or more of the plurality of sensors of the sensor system, the connector being in operative connection with the control system.

20. The wheelchair system of claim 16 wherein the at least one application is stored on the at least one memory component of the personal communication device and is executed by the at least one processor of the personal communication device.

21. The wheelchair system of claim 20 wherein the at least one application is adapted to request data from the sensor system and as a background service on the personal communication device.

22. The wheelchair system claim 21 wherein the at least one application is adapted to sense when the personal communication system is in communication with the sensor system and to automatically request data from the sensor system when the personal communication system is in communication with the sensor system.

23. The wheelchair system of claim 21 wherein the at least one application requests data periodically from the sensor interface system as long as the sensor interface system is in communication with the personal communications device.

24. The wheelchair system of claim 1 wherein the wheelchair is a powered wheelchair comprising a control system and the at least one adjustable seating function comprises a power seating function in operative connection with the control system, the at least one application being adapted to adjust the at least one adjustable seating function via the controller system.

25. A method of providing information to a user of a wheelchair to assist the user to adjust a position of at least one adjustable seating function of the wheelchair, the method comprising:
providing a sensor system in operative connection with the wheelchair and comprising at least one of sensor to sense a position of the at least one adjustable seating function,
providing a processor system in operative connection with the sensor system,
providing a memory system in operative connection with the processor system,
providing a communication system in operative connection with the processor system, the communication system being adapted to wirelessly communicate with one or more remote systems;
providing a user interface system in operative connection with the processor system, and
executing at least one application stored on the memory system via the processor system to provide information via the user interface system to a user of the wheelchair related to data from the sensor system to assist the user to adjust the position of at least one adjustable seating function in accordance with parameters stored in the memory system.

26. A wheelchair system, comprising
a wheelchair comprising at least one adjustable seating function;
a sensor system in operative connection with the wheelchair comprising at least one of sensor to sense a position of the at least one adjustable seating function,
a processor system in operative connection with the sensor system,
a memory system in operative connection with the processor system,
a user interface system in operative connection with the processor system, and
at least one application stored on the memory system and executable by the processor system to provide information via the user interface system to a user of the wheelchair related to data from the sensor system to assist the user to adjust the position of at least one adjustable seating function in accordance with parameters stored in the memory system and to provide messages comprising at least one of reminders to the user via the user interface system to adjust the position of the at least one adjustable seating function and warnings to the user via the user interface system regarding the position of at least one adjustable seating functions.

27. The wheelchair system of claim 26 wherein one or more of the generated messages are dependent upon at least one of a location of wheelchair, a condition of the environment of the wheelchair, or an activity in which the user is involved.

28. The wheelchair system of claim 27 wherein the sensor system further comprises at least one of a sensor to determine the location of the wheelchair, a sensor to determine the condition of the environment of the wheelchair, or a sensor to determine a variable related to the activity in which the user is involved.

29. A system adapted to be placed in operative connection with a wheelchair including at least one adjustable seating function and a sensor system comprising at least one of a sensor for sensing elevation position of the at least one adjustable seating function, comprising:
a personal communication device comprising a communication system, a processor system, a memory system in operative connection with the processor, an operating system stored in the memory system and executable by the processor system and a user interface system in operative connection with the processor, and
a sensor interface system, the sensor interface system being operable to communicate data from the sensor system to the personal communication device, the personal communication device further comprising at least one application stored thereon and executable by the processor system to provide information via the user interface system to a user of the wheelchair related to the data from the sensor system to assist the user to adjust the position of at least one adjustable seating function in accordance with parameters stored in the memory system.
